(19) United States
(12) Patent Application Publication
(10) Pub. No.: US 2003/0209915 A1
(43) Pub. Date: Nov. 13, 2003

(54) Shock absorber

(75) Inventor: Hiroshi Yoshida, Soja-shi (JP)

Correspondence Address: Koda & Androlia, Suite 1430, 2029 Century Park East, Los Angeles, CA, 90067-3024, US

(73) Assignee: OM CORPORATION

(21) Appl. No.: 10/418,636

(22) Filed: Apr. 18, 2003

(30) Foreign Application Priority Data
May 10, 2002 (JP) 2002-136109

(51) Int. Cl. B60R 19/34

(52) U.S. Cl. 293/133

(57) ABSTRACT

In order to set up selectively a suitable displacement-load characteristics to absorb an impact energy adapting to the difference of the impact modes, a resistive-portion-comprised shock absorber 100 comprising a smaller-diameter tube portion 102 and a larger-diameter tube portion 103 which are integrally formed by partially reducing or partially enlarging a straight tube that can be plastically deformable, a step portion formed continuously between edge of the each smaller-diameter tube portion and the larger-diameter tube portion by being folded the edge back to the each tube portions, wherein a frictional resistive portion is provided to the smaller-diameter tube portion slidingly inserted into the larger-diameter tube portion, and, a resistive-member-mounted shock absorber 200 comprising a smaller-diameter tube portion 204 and a larger-diameter tube portion 202 which are described above, a step portion 207 which is described above, wherein a frictional member is mounted in an interior of the larger-diameter tube portion.

### BACKGROUND OF THE INVENTION

1. Field of the Invention

This invention relates to a shock absorber having a structure adapted to absorb impact energy as plastic deformation-generating energy when a vehicle bumper receives impact energy from the outside of the vehicle.

2. Description of the Related Art

The shock absorbers in the purpose of protecting occupants of a vehicle when the vehicle collides can be roughly classified into a cylinder type and a plastic deformation type. In a cylinder type, a shock absorber has a structure adapted to absorb impact energy therein as kinetic energy by which a rod is drawn back into a cylinder. In a plastic deformation type, a shock absorber has a structure adapted to absorb impact energy received from the outside of a vehicle, by transforming impact energy into deformation energy which leads a partial plastic deformation of the shock absorber or an entire plastic deformation thereof. The shock absorber of a plastic deformation type has the advantage of that can be manufactured in light and inexpensive. These advantages are included in, for example, Japanese Patent No. 47-045986, Japanese Patent No. 47-014535, Japanese Patent No. 48-002300, Japanese Patent No. 52-046344, Japanese Patent Laid-Open No. 48-001676, Japanese Patent Laid-Open No. 48-093045, Japanese Patent Laid-Open No. 49-000672, U.S. Pat. No. 3,143,321, U.S. Pat. No. 3,511,345 and U.S. Pat. No. 3,599,757.

Japanese Patent No. 47-014535 discloses a plastic load unit comprising a tube member (corresponding in a location to the smaller-diameter tube portion of the present invention) having a ductility, a non-plastic portion (corresponding in a location to the larger-diameter tube portion of the present invention) having larger (or smaller) diameter than an effective diameter of said tube member, and a rounded stepped portion (corresponding to the step portion of the present invention). According to this structure, the absorption of impact energy is achieved while the impact energy is transformed into deformation energy which causes the tube member to be folded back as the stepped portion is gradually plastically deformed. Japanese Patent No. 47-045986 also employs a similar structure.

Japanese Patent No. 48-002300 discloses a plastic load unit that is integrally formed by a larger diameter portion (corresponding to the larger-diameter tube portion of the present invention) and a smaller diameter portion (corresponding to the smaller-diameter tube portion of the present invention) through a rounded stepped portion (corresponding to the step portion of the present invention) The larger diameter portion and the smaller diameter portion are comprised to a tube member having an equal or a different thickness of walls of the portions. Where the plastic load unit according to the art receives impact, the impact energy is absorbed as deformation energy transformed by an intermediate tube portion generated as a result of that the small diameter portion is folded back by plastic deformation began at the stepped portion. A diameter of the intermediate tube portion is larger than the small diameter portion and is smaller than the larger diameter portion.

Japanese Patent No. 52-046344 discloses a shock absorber utilizing generation of buckling in the wall of tubes having wall thickness required to absorb further impact energy after restrained the progress of plastic deformation of the tubes as a premised absorber arranged in parallel on a common axis. The premised absorber is integrally formed by a smaller diameter portion (corresponding to the smaller-diameter tube portion of the present invention) and a larger diameter portion (corresponding to the smaller-diameter tube portion of the present invention) through a rounded stepped portion (corresponding to the step portion of the present invention).

Japanese Patent Laid-Open No. 48-001676 discloses a shock absorber comprising a smaller diameter portion (corresponding to the smaller-diameter tube portion of the present invention) and a larger diameter portion (corresponding to the larger-diameter tube portion of the present invention) which are arranged concentrically, an annular portion (corresponding to the step portion of the present invention) which is formed by folding back faced edges of the both diameter portions continuously, and a cut face inclined slightly against a direction of axis of the diameter portions. The cut surface has a function of varying the characteristics of the plastic deformation at the annular portion.

Japanese Patent Laid-Open No. 48-093045 discloses a buffer unit comprising a tubular portion having larger diameter (corresponding to the larger-diameter tube portion of the present invention), a tubular portion having smaller diameter (corresponding to the smaller-diameter tube portion of the present invention) and thereby arranging those tubular portions continuously in axial direction. The unit absorbs an impact energy transformed into a plastic deformation energy by pushing the tubular portion having smaller diameter into the tubular portion having larger diameter. And, Japanese Patent Laid-Open No. 49-000672 discloses a shock absorber having a structure in which an end portion of a rolled-back inner cylindrical member is brought into internal contact with an outer cylindrical member. The impact energy is absorbed as deformation energy causing plastic deformation to occur in the rolled-back portion, when impact applied to the inner cylindrical member.

U.S. Pat. No. 3,146,014 discloses a shock absorber having a structure adapted to absorb impact energy in which the absorption operation is effected by utilizing the energy of plastic deformation occurring in a straight metal tube (corresponding to the larger-diameter tube portion of the present invention) when the impact energy applied to a cylindrical member as a bumper attaching member (corresponding to the smaller-diameter tube portion of the present invention). This U.S. patent is different from other related art structures in that is comprised of two members (a straight metal tube and a bumper attaching member) but identical with that the impact energy is absorbed by utilizing the energy of the plastic deformation of the straight metal tube.

U.S. Pat. No. 3,511,345 discloses an energy absorber having a structure in which a first tubular portion (corresponding to the smaller-diameter tube portion of the present invention) and a second tubular portion (corresponding to the larger-diameter tube portion of the present invention) are connected together by a round stepped intermediate portion (corresponding to the step portion of the present invention) which connects end portions of the two tube portions together. The energy absorber absorbs the impact energy as deformation energy-generating plastic deformation at a stepped intermediate portion. U.S. Pat. No. 3,599,757 has a structure identical with that of the above US patent.

A plastic deformation type shock absorber usually has a mechanism for absorbing impact energy as deformation energy causing plastic energy to occur which is needed to sink a smaller-diameter tube, which is pushed by the impact energy, into a larger-diameter tube. The correlation between a volume of deformation (measurement of sinking) of the smaller-diameter tube and that of the impact energy absorbed as deformation energy causing plastic deformation to occur can be expressed as deformation-load characteristics. These deformation-load characteristics show a tendency to proportionally increase at such time that is immediately after the deformation of the smaller-diameter tube has started. However, when the plastic deformation once becomes steady, the amount of impact energy capable of being absorbed in the shock absorber tends to become constant irrespective of an increase in the amount of displacement of the smaller-diameter tube. Since a total amount of impact energy capable of being absorbed in a shock absorber is equal to an integral amount (indicating as a hatched area in a graph) of displacement-load characteristics, a total amount of the impact energy capable of being absorbed in the shock absorber can also be increased when an amount by which the smaller-diameter tube can be displaced is increased.

However, an amount of absorption of the impact energy needed by a shock absorber differs depending upon the weight of vehicles (a small-sized vehicle, a medium-sized vehicle or a large-sized vehicle), and speeds at which the vehicle is collided (low-speed collision or high-speed collision). For example, in the case of low-speed collision of a vehicle, the impact energy is naturally small, and it is preferable that an amount of absorption of impact energy in a shock absorber be small as well. Assuming that a shock absorber having an excessively large amount of energy absorption is used for a low-speed collision of a vehicle, a load on a vehicle body becomes high, and there is the possibility that the vehicle body and occupants of the vehicle with which a subject vehicle collided and the vehicle body and occupants of the subject vehicle be damaged. Therefore, in the case of low-speed collision of a vehicle, it is desirable that a shock absorber having a comparatively small amount of energy absorption and suited to small impact energy to occur be used irrespective of the weight of the vehicle.

On the other hand, in the case of high-speed collision of a vehicle, a shock absorber having a large amount of energy absorption enabling large impact energy to be absorbed therein sufficiently becomes necessary. In order to attain a large amount of impact energy absorption, it is conceived that, first, a structure for simply increasing an amount of displacement of a smaller-diameter tube be employed. However, this simultaneously causes an increase, which is consequent upon the enlargement of an energy absorption apparatus, in the volume of a vehicle body in which the energy absorber is installed. Therefore, in order to increase only a total amount of impact energy absorption, it is recommended that a shock absorber be formed so that the shock absorber has displacement-load characteristics allowing an amount of the impact energy absorption to increase in proportion to the amount of displacement of the smaller-diameter tube even after the plastic deformation of the mentioned tube has become steady. At the same time, the shock absorber having displacement-load characteristics allowing an amount of the impact energy absorption increasing tendency to be retained even after such plastic deformation has become steady must not break the limit of the strength of the vehicle body which is substantially proportional to the weight of the vehicle. Therefore, it is necessary in this plastic deformation type shock absorption apparatus that an upper limit value of the amount of impact energy absorption can be set in accordance with a limit of the strength of each vehicle body.

Thus, a shock absorber utilizing plastic deformation has the advantage of being manufactured to small weight inexpensively but it was difficult to satisfy the displacement-load characteristics of a shock absorption apparatus required on the basis of a difference in the weight of vehicles and a difference in vehicle speeds at the time of collision thereof. Under the circumstances, the development of a plastic deformation type shock absorber capable of selectively setting suitable displacement-load characteristics so that the impact energy can be absorbed in accordance with a mode of collision of a vehicle including the differences in the weight of the vehicle and a vehicle speed at the time of collision thereof was discussed as a problem to be solved by the present invention.

### SUMMARY OF THE INVENTION

The present invention has solved the problem by providing a shock absorber with utilizing a resistance for restraining or reducing the plastic deformation of a smaller-diameter tube portion. First, as a structure of a shock absorber provided a resistive portion to a smaller-diameter tube portion, a shock absorber comprising a smaller-diameter tube portion and a larger-diameter tube portion which are integrally formed by partially reducing or partially enlarging a straight tube that can be plastically deformable through a step portion connecting the smaller-diameter tube portion and the larger-diameter tube portion, and providing a resistance function to the smaller-diameter tube portion by friction occurred with sliding the smaller-diameter tube portion into the larger-diameter tube portion, has been developed (hereinafter be referred to as a resistive-portion-comprised shock absorber). A basic structure of the resistive portion in the resistive-portion-comprised shock absorber is that a truncated cone shaped tube, having an outer diameter larger than an inner diameter of the annular folded-back portion of the larger-diameter tube portion, is press-inserted to the interior of the larger-diameter tube portion.

The resistive-portion-comprised shock absorber according to the present invention has a structure based on the fact that a smaller-diameter tube portion is absorbed into a larger-diameter tube portion without being inclined, and, in this structure, the sinking of the smaller-diameter tube portion into the larger-diameter tube portion is restrained or reduced by the resistive portion utilizing friction. In order to have the smaller-diameter tube portion absorbed in the larger-diameter tube portion without being inclined, it is desirable that a step portion is formed in a cross section by connecting together a cross-sectional circular arc-shaped annular folded-back portion of the smaller-diameter tube portion having a smaller radius of curvature and a cross-sectional circular arc-shaped annular folded-back portion of the larger-diameter tube portion having a larger radius of curvature.

The resistive portion in the resistive-portion-comprised shock absorber contacts the annular edge of the larger-diameter tube portion while the smaller-diameter tube portion is absorbed in the larger-diameter tube portion, and is then press-inserted to the larger-diameter tube portion with enlarging the diameter of the larger-diameter tube portion. As a result, the plastic deformation of the larger-diameter tube portion is restrained or reduced. In order to absorb impact energy as deformation energy, plastic deformation has to be generated in the larger-diameter tube portion against the restraint of and a decrease in the plastic deformation power thereof. Therefore, larger deformation energy the level of which is within a range needed to carry out plastic deformation restraining or reducing operation becomes necessary. This enables larger impact energy to be absorbed. This means in view of the plastic deformation process that an amount of energy absorption is increased.

The impact energy is absorbed as deformation energy which causes plastic deformation of the larger-diameter tube portion in which the side surface of the larger-diameter tube portion is rolled up inward from the annular edge of the larger-diameter tube portion (hereinafter referred to as a primary absorption action) where the smaller-diameter tube portion is absorbed in the larger-diameter tube portion, and plastic deformation of the larger-diameter tube portion in which the diameter of the larger-diameter tube portion enlarges from the annular edge of the larger-diameter tube portion (hereinafter referred to as an additional absorption action) where the resistive portion is press-inserted to the interior of the larger-diameter tube portion. This enables, a total amount of the impact energy to increase (i.e. additional absorption action works substantially constant), and an amount of energy absorption to increase (i.e. additional absorption action increases) in accordance with an amount of displacement of the smaller-diameter tube.

The additional absorption action includes friction occurring between the rolled-up annular edge of the larger-diameter tube portion and the side surface of a frictional resistive portion as being the resistive portion. Both the primary absorption action and additional absorption action include mainly plastic deformation. Therefore, it is desirable that the primary and additional absorption actions occur continuously and smoothly and absorb the impact energy continuously. The reason is that the intermittent or sudden absorption of impact energy imparts a shock to a vehicle body and the occupants even when a total amount of energy absorption is increased.

For example, as described in Japanese Utility Model Publication No. 06-022112, the intermittent absorption of impact energy is appeared to load-deformation volume characteristics (deformation-load characteristics in the present invention) in a structure having a two-step action of that, first, causing a member to be broken (absorption of the impact energy owing to the breakage of the member), and then press-fitting the broken member onto the other member (absorption of the impact energy owing to the plastic deformation of the member).

In order to attain the continuous and smooth absorption of the impact energy, it is necessary to smoothly generate the plastic deformation of the tube portion based on the prior primary absorption action without causing the stepped portion to be broken, especially, immediately after the application of a shock to the mentioned tube.

In the resistive-portion-comprised shock absorber according to the present invention, smaller-diameter and larger-diameter tube portions, which are obtained by partially reducing or partially enlarging the diameter of a plastically deformable straight tube, and which are connected to each other via a step portion, are formed. Therefore, the wall thickness of the larger-diameter tube portion becomes smaller than that of the smaller-diameter tube portion, and the larger-diameter tube portion relatively becomes easy to be plastically deformed. A step portion having a sectional structure, in which a cross-sectional circular arc-shaped annular folded-back portion of the smaller-diameter tube portion having a smaller radius of curvature in a cross section thereof and an annular edge of the larger-diameter tube portion having a larger radius of curvature in a cross section thereof are jointed together by an annular side surface, also works to generate smooth plastic deformation of the smaller-diameter tube portion. Thus, the resistive-portion-comprised shock absorber according to the present invention has a structure being capable to achieve the generation of the smooth elastic deformation without causing the breakage utilizing by a difference of thickness between walls of the smaller-diameter tube portion and of the larger-diameter tube portion, together with the provision of the step portion of the above-mentioned sectional structure.

In order to attain the generation of a continuous and stable primary absorption action, it is desirable that the smaller-diameter tube portion is absorbed in the larger-diameter tube portion without inclination of the smaller-diameter tube portion while being inserted. The annular side surface in the step portion, which connects the annular side surface of the smaller-diameter tube portion and annular edge of the larger-diameter tube portion together, prevents the smaller-diameter tube portion from inclination occurred by the impact at early stage, utilizing by a sliding contact of a side surface of the smaller-diameter tube portion. At the beginning of that the smaller-diameter tube portion is absorbed in the larger-diameter tube portion, the inclination of the smaller-diameter tube portion is corrected in sliding contact with the annular side surface, and then a reliable sinking of the smaller-diameter tube portion is thereby ensured.

A frictional resistive portion as the resistive portion in the resistive-portion-comprised shock absorber may have an outer diameter larger than the inner diameter of the annular folded-back portion of the larger-diameter tube portion. For example, it is illustrated in a structure of a frictional resistive portion being provided to a side surface of the smaller-diameter tube portion which is shaped in a truncated cone obtained by gradually enlarging an outer diameter of the smaller-diameter tube portion from the step portion toward a free edge of the smaller-diameter tube portion until the outer diameter becomes larger than an inner diameter of the annular folded-back portion of the larger-diameter tube portion (hereinafter referred to as a truncated-cone-shaped resistive portion) Further a structure of a frictional resistive portion being provided to the side surface of the smaller-diameter tube portion having an outer diameter thereof larger than the inner diameter of the annular folded-back portion of the larger-diameter tube portion as being an enlarged straight tube (hereinafter referred to as an uniaxial aligned tubular resistive portion).

The truncated-cone-shaped resistive portion generates increasingly an additional absorption action for enlarging the diameter of the section between the annular folded-back portion of the larger-diameter tube portion and the side surface of the larger-diameter tube portion in accordance with the angle of inclination of the side surface thereof. The additional absorption action is suitably applied to a case where the amount of the impact energy absorption is desired to increase continuously since the additional absorption action increases in proportion to the amount of the sinking of the truncated-cone-shaped resistive portion with respect to the larger-diameter tube.

The uniaxial aligned tubular resistive portion generates an additional absorption action for which expands a section between the annular folded-back portion of the larger-diameter tube portion and the side surface of the larger-diameter tube portion in proportion to the outer diameter of the side surface of a smaller-diameter straight tube portion thereof. The additional absorption action is generated by the sinking of the uniaxial aligned tubular resistive portion into the larger-diameter tube portion from the annular folded-back portion of the larger-diameter tube portion toward the side surface of the larger-diameter tube portion with a predetermined increasing rate of a diameter. Therefore, the amount of the impact energy absorption increases totally and not in accordance with the volume of displacement of the smaller-diameter tube portion, i.e., this amount of absorption becomes constant.

The truncated-cone-shaped resistive portion and the uniaxial aligned tubular resistive portion can be used jointly as well as used them solely respectively. In case of where these resistive portions are used in a successively arranged state, the displacement-load characteristics showing variation of amount of energy absorption corresponding to the volume of displacement of the smaller-diameter tube portion can be obtained.

For example, the jointed resistive portion formed by a smaller-diameter straight tube portion of the uniaxial aligned tubular resistive portion and the truncated-cone-shaped resistive portion is to be available (hereinafter referred to as a restraining type resistive portion). In this case, the smaller-diameter straight tube portion having a same diameter of its side surface to the outer diameter of the free edge of the truncated-cone-shaped smaller-diameter tube portion is continuously provided from the outer diameter of the free edge in which is enlarged the outer diameter of the smaller-diameter tube portion gradually from the step portion toward the free edge of the smaller-diameter tube portion until the outer diameter becomes larger than the inner diameter of the annular folded-back portion of the larger-diameter tube portion. This restraining type resistive portion can restrain the generation of an additional absorption action by transforming an amount of the energy absorption, which continues to be increased by a first half side surface portion of the truncated-cone-shaped resistive portion in accordance with a volume of displacement of the small-diameter tube portion, to a predetermined level by a next half side surface portion of the uniaxial aligned tubular resistive portion. This restraining type resistance is effectively used when it is desired that a limitation be placed on an impact capable of being absorbed in relation to the strength of a vehicle body with respect to a high-speed collision of a small-sized vehicle in a resistive-portion-comprised shock absorber having a totally large amount of impact energy absorption.

A resistive portion having the construction of which is contrary to that of the restraining type resistive portion may also be formed which has a straight tube portion obtained by enlarging the outer diameter of a smaller-diameter tube portion to a level higher than that of the inner diameter of a cross-sectional circular arc-shaped annular folded-back portion of a larger-diameter tube portion, a side surface of this straight tube portion being followed by a side surface of a truncated-cone shaped resistive portion having its diameter in which gradually increases from an edge of a side surface of the straight tube portion toward a free edge of the smaller-diameter tube portion (hereinafter referred to as a reinforcing type resistive portion). This increasing type resistive portion is capable of transforming again the amount of the energy absorption which was constant irrespective of the volume of displacement of the smaller-diameter tube portion owing to the side surface of the straight tube portion, a first half of the resistance to the condition in which the amount of the energy absorption has a tendency to increase with the lapse of time. Thus, the additional absorption action can be increased. This increasing type resistive portion is effectively provided in a truncated-cone-shaped resistive portion, which is formed so as to restrain the absorption of impact energy, for where an impact becomes exceptionally large due to high-speed collision of a vehicle, i.e., where there is a desire to suitably increase the amount of the energy absorption of the shock absorber.

Further, where there is desired that the generation of an additional absorption action can be delayed, a non-resistive portion having an outer diameter smaller than the inner diameter of the annular folded-back portion of the larger-diameter tube portion can be provided between the annular folded-back portion of the smaller-diameter tube portion and the frictional resistive portion. Since the non-resistive portion has an outer diameter smaller than an inner diameter of a cross-sectional circular arc-shaped annular folded-back portion of the larger-diameter tube portion, the non-resistive portion is not press-contacted with the annular folded-back portion of the larger-diameter tube portion at a beginning of that the smaller-diameter tube portion is absorbed into the larger-diameter tube portion. Therefore, the absorption of the impact energy is only shown in the primary absorption action as the plastic deformation of which rolls up from the annular folded-back portion of the larger-diameter tube portion to the side surface of the larger-diameter tube portion. Namely, a delay action for standing by the generating of an additional absorption action until the frictional resistive portion reaches the annular folded-back portion of the larger-diameter tube portion can be set. This non-resistive portion is effectively provided in a case where the generation of an additional absorption action is prevented at the time of low-speed collision of a vehicle, i.e., where in a stage of collision in which a large amount of an energy absorption is not required in a resistive-portion-comprised shock absorber in which an amount of the impact energy absorption is totally large.

Next, as a structure of a shock absorber that a resistive member is provided with a larger-diameter tube portion, the shock absorber comprising a smaller-diameter tube portion and a larger-diameter tube portion which are integrally formed by partially reducing or partially enlarging a straight tube that can be plastically deformable through a step portion connecting the smaller-diameter tube portion and the larger-diameter tube portion, and providing a resistance function to the smaller-diameter tube portion by friction occurred with sliding the smaller-diameter tube portion into the resistive member mounted in the larger-diameter tube portion, has been developed (hereinafter referred to as a resistive-member-mounted shock absorber) The resistive-member-mounted shock absorber, in the same manner as the aforementioned resistive-portion-comprised shock absorber, has a structure based on the fact that the smaller-diameter tube portion is absorbed into a larger-diameter tube portion without being inclined, and thereby being possible to regulate an amount of the impact energy absorption. In view of above, in order to have the smaller-diameter tube portion absorbed in the larger-diameter tube portion absorbed in the larger-diameter tube portion without being inclined, it is desirable that a structure of a step portion is formed in a cross section by connecting together a cross-sectional circular arc-shaped annular folded-back portion of the smaller-diameter tube portion having a smaller radius of curvature and a cross-sectional circular arc-shaped annular folded-back portion of the larger-diameter tube portion having a larger radius of curvature.

In the resistive-member-mounted shock absorber, which is different from the aforementioned resistive-portion-comprised shock absorber, the absorption of impact energy owing to the plastic deformation of the larger-diameter tube portion is carried out by a primary absorption action alone, and the action of the frictional resistive member restrains or reduces the displacement of the smaller-diameter tube portion which causes the plastic deformation of the larger-diameter tube portion to occur. Therefore, in order to generate this plastic deformation, larger deformation energy is needed, so that larger impact energy is necessarily absorbed. In view of the plastic deformation process, this means that the amount of the energy absorption is increased.

Restraining or reducing the displacement of the smaller-diameter tube portion referred to in this paragraph means restraining the sinking of the smaller-diameter tube portion and reducing a sinking speed of the smaller-diameter tube portion by the resistive member. The former is an action made so as to increase the amount of the energy absorption in proportion to mainly the degree of sinking of the smaller-diameter tube portion (hereinafter referred to as a sinking restraining action). The latter is an action made at a constant rate with respect to mainly the sinking of the smaller-diameter tube portion into the larger-diameter tube portion (hereinafter referred to as a speed reducing action). In the restraining or reducing displacement of the smaller-diameter tube portion of the resistive-member-mounted shock absorber, the plastic deformation of the larger-diameter tube portion occurs owing to such a displacement restraining or reducing action of the smaller-diameter tube only when impact energy overcoming the resistive member's speed reducing action and sinking restraining action is exerted on the smaller-diameter tube portion. When these characteristics are utilized properly, it becomes possible to set the range of an increase in the amount of the energy absorption narrower at the time of low-speed collision of a vehicle, and wider at the time of high-speed collision thereof.

The construction of each of the portions including the smaller-diameter tube portion, the larger-diameter tube portion and the step portion constituting the resistive-member-mounted shock absorber corresponds to that of each of such members of the above-described resistive-portion-comprised shock absorber. Since the smaller-diameter tube portion or the larger-diameter tube portion is formed by partially reducing or partially increasing the diameter of, for example, a straight tube that can be plastically deformable, the wall thickness of the larger-diameter tube portion becomes smaller than that of the smaller-diameter tube portion, so that the larger-diameter tube portion is deformed relatively easily. The step portion including a sectional structure in which the annular folded-back portion of the smaller-diameter tube portion having a small radius of curvature of a cross section thereof and the annular folded-back portion of the larger-diameter tube portion having a large radius of curvature of a cross section thereof are jointed together by an annular side surface, also works to generate smooth plastic deformation of the smaller-diameter tube portion. Furthermore, when the smaller-diameter tube portion starts being absorbed in the larger-diameter tube while being inclined, the annular side surface of the step portion corrects the mentioned inclination as this annular side surface slidingly contacts the side surface of the smaller-diameter tube portion in an early stage. As a result, the reliable sinking of the smaller-diameter tube portion into the larger-diameter tube portion is effected.

Specific examples of the structure for the resistive-member-mounted shock absorber are shown in the following, such as; a structure in which a annular rigid member, the outer diameter of which is smaller than the inner diameter of a larger-diameter tube portion, and the inner diameter of which is larger than the outer diameter of the annular folded-back portion of a smaller-diameter tube portion, is inserted into the interior of the larger-diameter tube portion; a structure in which an annular elastic member, the outer diameter of which is smaller than the inner diameter of a larger-diameter tube portion, and the inner diameter of which is larger than the outer diameter of the side edge of a smaller-diameter tube portion is inserted into the interior of the larger-diameter tube portion; and a structure in which an annular composite elastic member obtained by engaging with each other in one body an annular elastic member, the outer diameter of which is smaller than the inner diameter of a larger-diameter tube portion, and an annular rigid member, the inner diameter of which is larger than the outer diameter of the side edge of a smaller-diameter tube portion, is inserted into the interior of the larger-diameter tube portion.

In each of these annular members, the smaller-diameter tube portion has an outer diameter smaller than the inner diameter of the larger-diameter tube portion, and an inner diameter larger than the outer diameter of the side edge of the smaller-diameter tube portion, so that, basically, the smaller-diameter tube portion can be moved at the interior of the larger-diameter tube portion freely, though there are partial friction occurred between the annular member and the side surface of the larger-diameter tube portion. Therefore, when an impact is applied from the smaller-diameter tube portion to the larger-diameter tube portion in the resistive-member-mounted shock absorber, the frictional resistive member moves inertially toward the smaller-diameter tube portion at a moving rate proportional to the magnitude of the impact. At the time of low-speed collision of a vehicle, the amount of the inertial movement of the resistive member is small. Especially, when a small impact is applied to the small-diameter tube portion, the movement of the resistive member is prevented owing to the partial friction mentioned above, and the impact energy is absorbed by only the plastic deformation of the larger-diameter tube portion with sinking of the smaller-diameter tube portion.

However, at the time of high-speed collision of a vehicle, the resistive member is moved greatly to reach the annular folded-back portion of the larger-diameter tube portion, and held between the annular side surface of the larger-diameter tube portion and the step portion (especially, the annular folded-back portion of the larger-diameter tube portion) owing to the elastic deformation of the smaller-diameter tube portion caused by the sinking itself into the larger-diameter tube portion, and thereby becoming the resistance against the annular folded-back portion of the larger-diameter tube portion which is displaced rearward in accordance with the elastic deformation of the larger-diameter tube portion. Thus, each annular member selectively displays a speed reducing action for reducing the sinking speed of the smaller-diameter tube portion on the basis of a difference in the vehicle speed at the time of collision, and renders it possible in consequence to regulate the amount of the energy absorption.

The annular rigid member is moved to the annular folded-back portion of the larger-diameter tube portion at the time of high-speed collision of a vehicle, and displays a speed reducing action. An annular metal body (metal ring) can be taken up a concrete example of the material for the annular rigid member.

The annular elastic member has a high degree of partial friction as compared with the annular rigid member, and a relatively small amount of inertial movement. Therefore, even in the case of high-speed collision of a vehicle in which a speed reducing action is more displayed, setting an amount of the energy absorption on the assumption that high-speed collision of a vehicle occurs, it becomes more possible than in the case where the annular rigid member is used. An annular rubber body (rubber ring) can be taken up as an example of a concrete material for the annular elastic member. When the annular elastic member can be compressed in proportion to the sinking of the smaller-diameter tube portion into the larger-diameter tube portion, the annular elastic member may be formed to an elastic tube having a length which allows the annular elastic member to be brought into close contact with the whole region of the annular side surface of the larger-diameter tube portion. In this case, the annular folded-back portion of the larger-diameter tube portion compresses the elastic tube as this annular folded-back portion is displaced at the time of the elastic deformation of the larger-diameter tube portion, and a load needed in accordance with the progress of the sinking of the smaller-diameter tube portion into the larger-diameter tube portion increases. This enables the amount of the energy absorption to be regulated in proportion to the speed of a vehicle at the time of collision thereof.

The annular composite member is suitably used to attain the structural strength of the annular rigid body as a speed reducing action which enables the amount of the collision energy absorption at a collision speed, which is higher than that seen as the characteristics of the annular elastic body, to be set is utilized properly.

In case of a more positive sinking restraining action is required, similar structures to the abovementioned resistive members, it can be realized by; a structure in which an annular rigid member having the outer diameter of which is substantially equal to the inner diameter of a larger-diameter tube portion, and the inner diameter of which is larger than the outer diameter of a side edge of the smaller-diameter tube portion is press-inserted in the interior of the larger-diameter tube portion; a structure in which an annular elastic member having the outer diameter of which is substantially equal to the inner diameter of a larger-diameter tube portion, and the inner diameter of which is larger than the outer diameter of a side edge of the smaller-diameter tube portion is press-inserted in the interior of the larger-diameter tube portion; and a structure in which an annular composite member formed by combining an annular elastic member having the outer diameter substantially equal to the inner diameter of the larger-diameter tube portion and an annular rigid member having the inner diameter larger than the outer diameter of the annular folded-back portion of the smaller-diameter tube portion in one body by a fitting operation, is press-inserted into the larger-diameter tube portion.

In each of these structures, due to that the diameter of each annular members is substantially equal to the inner diameter of the larger-diameter tube portion, friction occurs between the outer surface of the annular member and the side surface of the larger-diameter tube portion, and thereby restraining a movement of the annular member occurring at the time of collision of a vehicle. Therefore, a speed reducing action and a sinking restraining action of the annular member is displayed only at the time of high-speed collision of a vehicle. An annular member having a hooking portion to hook a side surface of a larger-diameter tube portion in absorption direction of the smaller-diameter tube portion may be provided. The difference among the annular rigid member, annular elastic member and annular composite member is identical with the above-described differences among the annular members.

The resistive members made of different annular bodies mentioned above are displayed mainly an action of reducing the sinking speed of the smaller-diameter tube portion, and thereby attain to control the regulation of an amount of the energy absorption based on a difference of the sinking speed of the smaller-diameter tube portion. However, when the initial position of each annular member is shifted easily due to the vibration of an automobile, the speed of the automobile at time of collision thereof, at which a speed reducing action is displayed, becomes different, and the displacement-load characteristics could change due to accidental affairs.

Therefore, each resistive member made of one of the above-mentioned different annular members may be elastically supported on an elastic member with respect to the larger-diameter tube portion. Such a support structure may be, for example, a structure formed by fixing a rear end of a coiled spring to a rear edge of a larger-diameter tube portion, connecting a rear portion of a resistive member made of one of the above-mentioned annular member to a front end of the coiled spring, and thereby elastically supporting the resistive member from the mentioned rear edge toward a smaller-diameter tube portion. When the resistive member is elastically supported in this manner on the elastic member, a forward or backward movement of the annular member in the interior of the larger-diameter tube portion due to an external force is prevented, and the initially set position of the annular member is maintained. This enables the annular member to be moved necessarily in only the direction in which the annular folded-back portion of the larger-diameter tube portion exists.

### BRIEF DESCRIPTION OF THE DRAWINGS

Preferred embodiments of the present invention will be described with reference to the following drawings, wherein:

FIG. 1 is a perspective view of a resistive-portion-comprised shock absorber provided with a truncated-cone shaped resistive portion in a smaller-diameter tube portion;

FIG. 2 is an axial sectional view showing the condition of the resistive-portion-comprised shock absorber to which an impact has not yet been applied;

FIG. 3 is an enlarged view taken in the direction of an arrow A in FIG. 2;

FIG. 4 is an axial sectional view showing the condition of the resistive-portion-comprised shock absorber to which an impact has been applied;

FIG. 5 is a graph showing the displacement-load characteristics of the resistive-portion-comprised shock absorber;

FIG. 6 is a perspective view, which corresponds to FIG. 1, of a resistive-portion-comprised shock absorber provided with an uniaxial aligned tubular non-resistive portion between a truncated-cone shaped resistive portion and a cross-sectional circular arc-shaped annular folded-back portion of the smaller-diameter tube portion;

FIG. 7 is an axial sectional view showing the condition of the resistive-portion-comprised shock absorber to which an impact has not yet been applied;

FIG. 8 is an axial sectional view showing the condition of the resistive-portion-comprised shock absorber in which the smaller-diameter tube portion was absorbed till an uniaxial aligned tubular non-resistive portion completely sunken after an impact had been applied to the smaller-diameter tube portion;

FIG. 9 is an axial cross-sectional view showing the condition in which the smaller-diameter tube portion in the mentioned sunken state is further press-inserted till a truncated-cone shaped resistive portion sunken;

FIG. 10 is a graph showing the displacement-load characteristics of the resistive-portion-comprised shock absorber;

FIG. 11 is a perspective view, which corresponds to FIG. 1, of a resistive-portion-comprised shock absorber provided with an uniaxial aligned tubular non-resistive portion between a restraining type resistive portion and a cross-sectional circular arc-shaped annular folded-back portion of a smaller-diameter tube portion;

FIG. 12 is an axial sectional view showing the condition of the resistive-portion-comprised shock absorber to which an impact has not yet been applied thereto;

FIG. 13 is an axial sectional view showing the condition in which the smaller-diameter tube portion was absorbed till the uniaxial aligned tubular resistive portion after an impact had been applied to the resistive-portion-comprised shock absorber;

FIG. 14 is an axial sectional view showing the condition in which the smaller-diameter tube portion in the mentioned sunken state was further press-inserted till a truncated-cone-shaped side surface of a restraining type resistive portion;

FIG. 15 is an axial sectional view showing the condition in which the smaller-diameter tube portion in the mentioned sunken state was further press-inserted till a side surface of the uniaxial aligned tube of the restraining type resistive portion;

FIG. 16 is a graph showing the displacement-load characteristics of the resistive-portion-comprised shock absorber;

FIG. 17 is a perspective view, which corresponds to FIG. 1, of a resistive-portion-comprised shock absorber made of a smaller-diameter tube portion provided with an uniaxial aligned tubular resistive portion and larger-diameter tube portion;

FIG. 18 is an axial sectional view showing the condition of the resistive-portion-comprised shock absorber to which an impact has not yet been applied;

FIG. 19 is an enlarged view taken along an arrow B in FIG. 18;

FIG. 20 is an axial sectional view showing the condition of the resistive-portion-comprised shock absorber to which an impact was applied;

FIG. 21 is a graph showing the displacement-load characteristics of the resistive-portion-comprised shock absorber;

FIG. 22 is a perspective view, which corresponds to FIG. 1, of a resistive-portion-comprised shock absorber provided with an uniaxial aligned tubular non-resistive portion between an uniaxial aligned tubular resistive portion and a cross-sectional circular arc-shaped annular folded-back portion of a smaller-diameter tube portion;

FIG. 23 is an axial sectional view showing the condition of the resistive-portion-comprised shock absorber to which an impact has not yet been applied;

FIG. 24 is an axial sectional view showing the condition in which the smaller-diameter tube portion was absorbed till an uniaxial aligned non-resistive portion after an impact had been applied to the resistive-portion-comprised shock absorber;

FIG. 25 is an axial sectional view showing the condition in which the smaller-diameter tube portion in the mentioned sunken state was further press-inserted untill the uniaxial aligned tubular resistive portion;

FIG. 26 is a graph showing the displacement-load characteristics of the resistive-portion-comprised shock absorber;

FIG. 27 is a perspective view, which corresponds to FIG. 1, of a resistive-portion-comprised shock absorber provided with a reinforcing type resistive portion;

FIG. 28 is a perspective view of a related art basic resistive-portion-comprised shock absorber including a smaller-diameter tube portion and a larger-diameter tube portion;

FIG. 29 is an axial sectional view showing the condition of the resistive-portion-comprised shock absorber to which an impact has not yet been applied;

FIG. 30 is an enlarged view of a portion designated by an arrow C in FIG. 29;

FIG. 31 is an axial sectional view showing the condition of the resistive-portion-comprised shock absorber to which an impact has been applied;

FIG. 32 is a graph showing the displacement-load characteristics of the resistive-portion-comprised shock absorber;

FIG. 33 is a perspective view of a resistive-member-mounted shock absorber having an annular rigid member as a resistive member inserted in the interior of a larger-diameter tube portion;

FIG. 34 is a sectional view of the resistive-member-mounted shock absorber;

FIG. 35 is an enlarged sectional view of a portion designated by an arrow D in FIG. 34;

FIG. 36 is a sectional view taken along the arrow-carrying line E-E in FIG. 34;

FIG. 37 is a sectional view, which corresponds to FIG. 34, showing a movement of an annular rigid member at the time of a low-speed collision of a vehicle;

FIG. 38 is a sectional view, which corresponds to FIG. 34, showing a movement of the annular rigid member at the time of a high-speed collision of a vehicle;

FIG. 39 is a sectional view, which corresponds to FIG. 34, of a resistive-member-mounted shock absorber having an annular composite member as a resistive member inserted in a larger-diameter tube portion;

FIG. 40 is a sectional view, which corresponds to FIG. 34, of a resistive-member-mounted shock absorber having a resistive member, which is made of an annular rigid member provided with an annular hooking portion and supported on a coiled spring, inserted in a larger-diameter tube portion;

FIG. 41 is a sectional view, which corresponds to FIG. 38, of the resistive-member-mounted shock absorber at the time of high-speed collision of a vehicle;

FIG. 42 is a sectional view, which corresponds to FIG. 34, of a resistive-member-mounted shock absorber having as a resistive member, an annular elastic member which extends from a step portion to a rear edge of a larger-diameter tube portion, and which is inserted in the interior of the larger-diameter tube portion; and

FIG. 43 is a sectional view, which corresponds to FIG. 38, of the resistive-member-mounted shock absorber at the time of a high-speed collision of a vehicle.

### DESCRIPTION OF THE PREFERRED EMBODIMENTS

Regarding modes of embodiment of the present invention, resistive-portion-comprised shock absorbers and resistive-member-mounted shock absorbers will now be described in the mentioned order with reference to the drawings respectively.

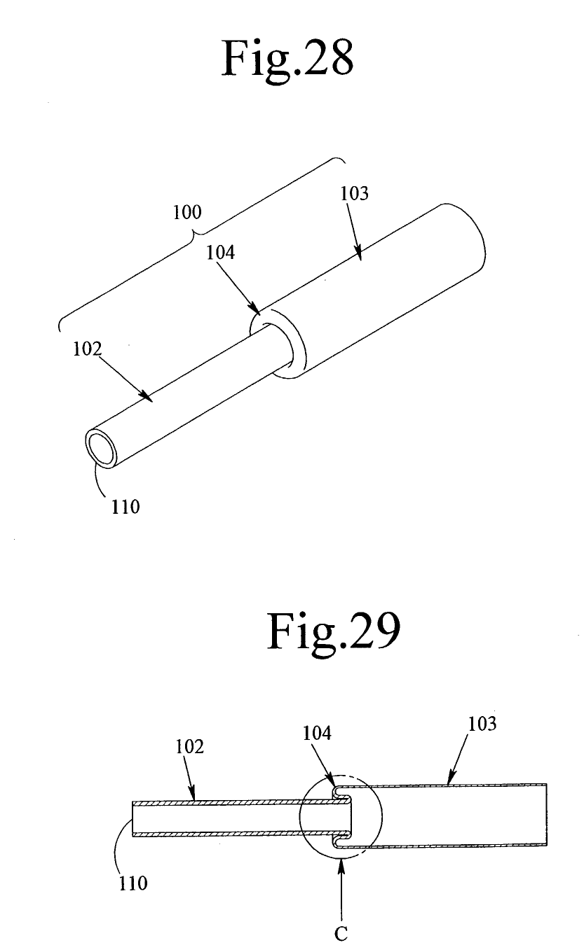

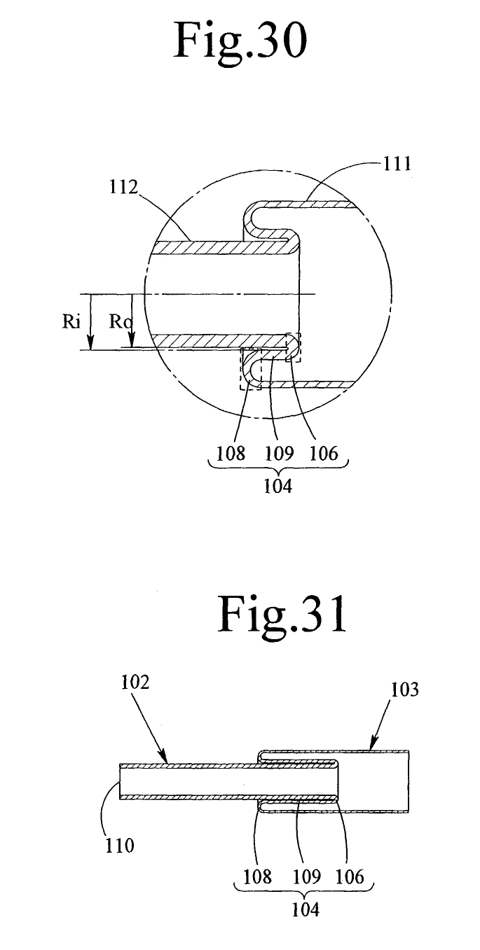

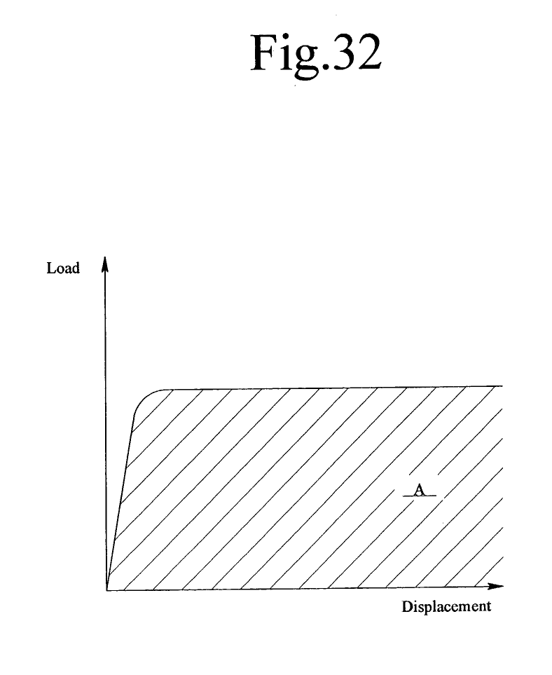

First, structural part common to the examples of the resistive-portion-comprised shock absorbers will be described. Each resistive-portion-comprised shock absorber 100 is formed on the basis of a structure (refer to FIG. 28) including a smaller-diameter tube portion 102 constituting a first stage, and a larger-diameter tube portion 103 constituting a latter stage, both of which tubes 102, 103 are obtained by reducing a diameter of a first stage of a straight metal tube that can be plastically deformable (or by enlarging a diameter of a latter stage of the same tube), and thereby forming in one body a resistive portion in the smaller-diameter tube portion 102. A step portion 104 has a sectional structure in which a cross-sectional circular arc-shaped annular folded-back portion 106 of the smaller-diameter tube portion formed by folding back a side surface 112 of the smaller-diameter tube portion and a cross-sectional circular arc-shaped annular folded-back portion 108 of the larger-diameter tube portion formed by folding back a side surface 111 of the larger-diameter tube portion are connected together by an annular side surface 109 made of a side surface of a straight tube.

A bumper structural member (not shown) is connected to a free edge 110 of the smaller-diameter tube portion 102, and a vehicle body member (not shown) to a rear edge of the larger-diameter tube portion 103 respectively, and the resistive-portion-comprised shock absorber 100 thereby supports the bumper structural member with respect to the vehicle body member. The smaller-diameter tube portion 102 is displaced toward the larger-diameter tube portion 103 via the bumper structural member and absorbed thereinto due to an impact received at the free edge 110 of the smaller-diameter tube portion 102.

The annular side surface 109 has a function of restraining or preventing the inclination of the smaller-diameter tube portion 102 when an impact is applied to the smaller-diameter tube portion in the diagonal direction, and sinking the smaller-diameter tube portion 102 into the larger-diameter tube portion 103 while correcting the inclination of the smaller-diameter tube portion 102. The resistive-portion comprised shock absorber 100 is formed so as to generate plastic deformation (primary absorption action) in which the larger-diameter tube portion is rolled inward from a cross-sectional circular arc-shaped annular folded-back portion 108 of the larger-diameter tube portion 103 toward a side surface 111 thereof due to the sinking of the smaller-diameter tube portion 102 into the larger-diameter tube portion 103.

A mode of primary shock absorption action utilizing the deformation energy for rolling round the smaller-diameter tube portion from the annular folded-back portion thereof toward a side surface of the same tube is also conceived. However, in the smaller-diameter tube portion 102 and larger-diameter tube portion 103, which are formed by partially reducing or partially enlarging the diameter of a straight tube that can be plastically deformable, the wall thickness of the larger-diameter tube portion having the side surface 111 is relatively smaller than that of the smaller-diameter tube portion having a side surface 112. In view of this structure, the mode of plastic deformation in which the larger-diameter tube portion is rolled round inward from the annular folded-back portion 108 of the larger-diameter tube portion toward the side surface 111 thereof is considered natural. Therefore, the present invention employs a plastic deformation structure in which the larger-diameter tube portion is rolled round from the annular folded-back portion 108 of the large-diameter tube portion toward the side surface 111 thereof.

In the case (Japanese Patent No. 52-046344) of plastic deformation in which a smaller-diameter tube is rolled round from a cross-sectional circular arc-shaped annular folded-back portion thereof toward a side surface thereof, an amount of displacement of the smaller-diameter tube becomes substantially a half of the length thereof since a bumper structural member is connected to the smaller-diameter tube portion. On the other hand, in the case of plastic deformation in which a larger-diameter tube portion is rolled round inward from a cross-sectional circular arc-shaped annular folded-back portion 108 of a larger-diameter tube portion toward a side surface 111 thereof, an amount of displacement of the smaller-diameter tube portion 102 becomes substantially equal to a distance at which the bumper structural member, to which the smaller-diameter tube portion 102 is connected, comes into contact with the vehicle body member, i.e. the length of the larger-diameter tube portion 103. As a result, the resistive-portion-comprised shock absorber 100 becomes able to have the advantage of attaining a large amount of displacement of the smaller-diameter tube portion.

In order to reliably generate in each example plastic deformation in which the larger-diameter tube portion is rolled round inward from the annular folded-back portion 108 of the larger-diameter tube portion toward the side surface 111 of the larger-diameter tube portion, each step portion 104 is formed to a sectional structure in which the annular folded-back portion 106 of the smaller-diameter tube portion made of an arc-shaped cross section of an angle of arc of substantially 180 degrees and the annular folded-back portion 108 of the larger-diameter tube portion are connected together. In this sectional structure, a radius of the arc-shaped cross section of the annular folded-back portion 106 of the smaller-diameter tube portion is set relatively small as compared with that of the arc-shaped cross section of annular folded-back portion 108 of the larger-diameter tube portion. Therefore, when the smaller-diameter tube portion 102 receives an impact, the annular folded-back portion 106 thereof is folded back at a relatively acute angle is less elastically deformed than the relatively gently continuing annular folded-back portion 108 of the larger-diameter tube portion. As a result, a primary absorption action brought about by the elastic deformation of the annular folded-back portion 108 of the larger-diameter tube portion occurs reliably.

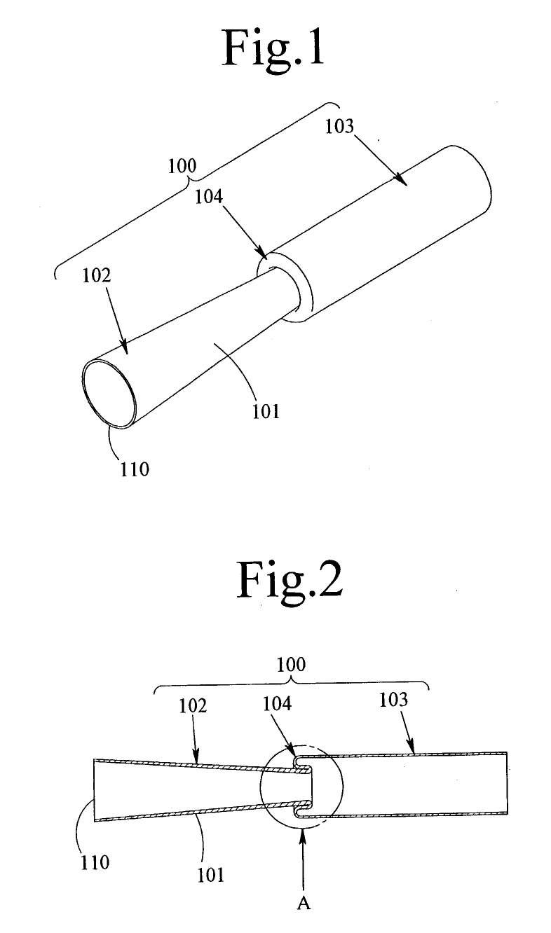

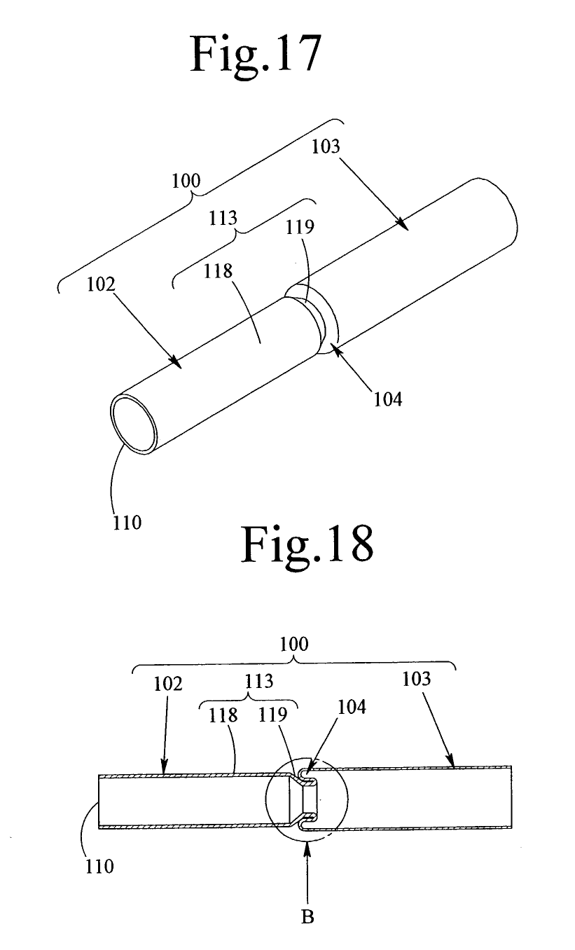

The differences between the examples reside in the construction of a resistive portion formed in the smaller-diameter tube portion 102 and the existence and non-existence of a non-resistive portion. When the resistive portion is press-inserted into the larger-diameter tube portion 103, the resistive portion generates plastic deformation (additional absorption action) of the larger-diameter tube portion, in which the diameter thereof is increased from the annular folded-back portion 108 thereof toward the side surface 111 thereof to cause the object impact energy to increase temporarily (truncated-cone shaped resistive portion 101, refer to FIG. 1) or in a stepped manner (resistive portion 113 of a straight tube, refer to FIG. 17). The non-resistive portion has an action of delaying the generation of the additional absorption action. The resistive-portion-comprised shock absorber 100 can be regulated so as to have various displacement-load characteristics by a combination of various kinds of resistive portion and a non-resistive portion.

In the resistive-portion-comprised shock absorber 100 seen in FIGS. 1 and 2, a truncated-cone shaped resistive portion 101 is formed which is obtained by increasing an outer diameter Ro of the smaller-diameter tube portion gradually and continuously from the annular folded-back portion 106 in the step portion 104 of the smaller-diameter tube portion toward the free edge 110 of the smaller-diameter tube portion 102 until the outer diameter Ro becomes larger than an inner diameter Ri of the annular folded-back portion of the larger-diameter tube portion. Namely, in this example, the smaller-diameter tube 102 is the truncated-cone shaped resistive portion 101, in which the outer diameter Ro of the smaller-diameter tube portion 102 is set larger (refer to FIG. 3) than the inner diameter Ri of the annular folded-back portion of the larger-diameter tube portion from an intermediate portion of the truncated-cone shaped resistive portion 101 to the free edge 110.

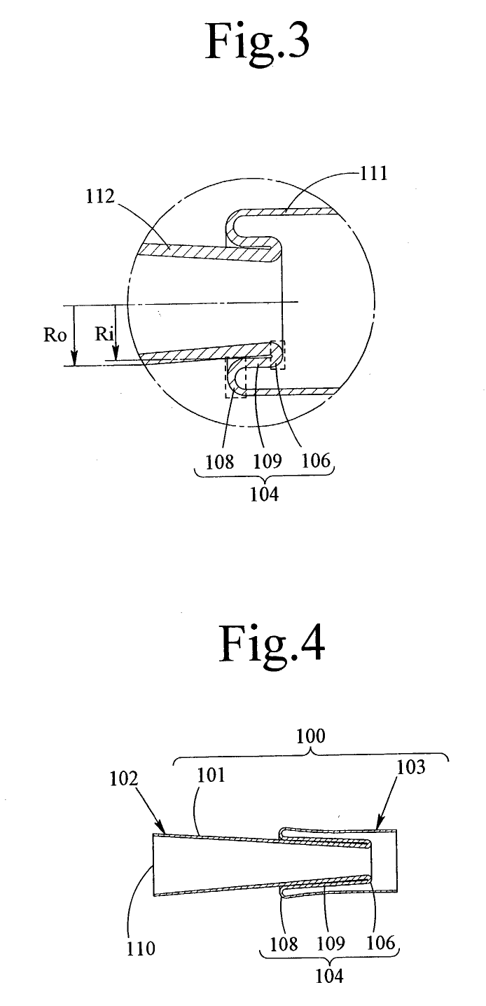

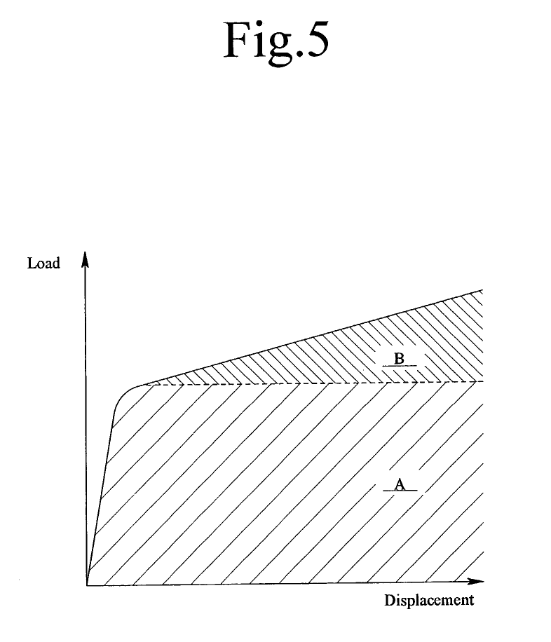

Therefore, when the smaller-diameter tube portion 102 receiving an impact starts being absorbed in the large-diameter tube portion 103 as seen in FIG. 4, a primary absorption action (region a in FIG. 5) of being rolled inward from the annular folded-back portion 108 of the larger-diameter tube portion toward the side surface 111 of the larger-diameter tube portion occurs, and an additional absorption action (region b in FIG. 5) as well in an increasing manner. This additional absorption action includes an action of increasing the diameter of the larger-diameter tube portion 103 by the truncated-cone shaped resistive portion 101, and, in addition to this, friction between an extended annular side surface 109 and a side surface of the truncated-cone shaped resistive portion 101 which is resulted from the inward rolling of the side surface 111 of the larger-diameter tube portion from the annular folded-back portion 108 of the larger-diameter tube portion during the diameter increasing action.

The resistive-portion-comprised shock absorber 100 seen in FIG. 1 onward is suitably utilized for large-sized vehicles, for example, trucks and buses. Since these large-sized vehicles have large mass, a large amount of impact energy is generated even at the time of a low-speed collision thereof. Therefore, it is desirable that the impact energy can be absorbed in accordance with the volume of displacement (measurement of sinking) of the smaller-diameter tube portion 102 from a stage of starting of the sinking of the smaller-diameter tube portion 102 into the larger-diameter tube portion. Moreover, since a large-sized vehicle has a high strength of a vehicle body, an upper limit of impact energy to be absorbed may not be provided. For these reasons, the resistive-portion-comprised shock absorber in this example, in which a primary absorption action and an additional absorption action occur at the same time, and in which, moreover, the additional absorption action increases in accordance with the sinking of the smaller-diameter tube portion 102 into the larger-diameter tube portion, suits a large-sized vehicle.

In the resistive-portion-comprised shock absorber 100 in this example, an amount of the energy absorption of a combination of a primary absorption action and an additional absorption action is large (area of the graph in FIG. 5=a region+b region: hatched region), so that a total length of the resistive-portion-comprised shock absorber 100 can be reduced. This enables the weight of the shock absorber 100 to be reduced.

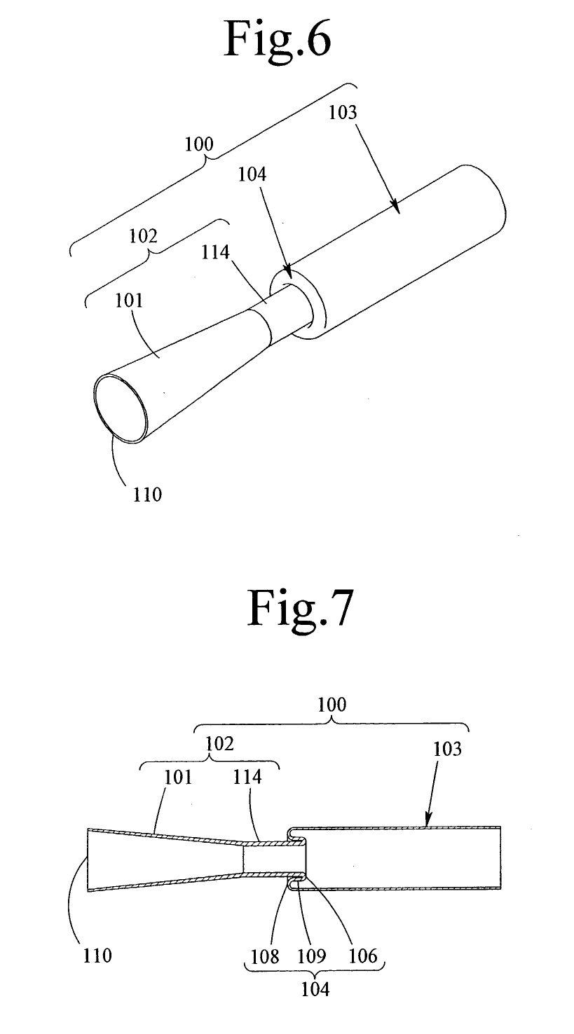

A resistive-portion-comprised shock absorber 100 shown in FIGS. 6 to 10 is an example provided with an uniaxial aligned tubular non-resistive portion 114, the outer diameter of which is not larger than the inner diameter of an annular side surface 109, between the same truncated-cone shaped resistive portion 101 and annular folded-back portion 106 of a smaller-diameter tube portion as are shown in the above-described example.

The resistive-portion-comprised shock absorber seen in FIGS. 6 and 7 is provided with the same truncated-cone shaped resistive portion 101 as shown in the previously-described example (refer to FIG. 1), and an uniaxial aligned tubular non-resistive portion 114 between this truncated-cone shaped resistive portion 101 and a cross-sectional circular arc-shaped annular folded-back portion 106 of a smaller-diameter tube portion. Namely, in this example, the smaller-diameter tube portion 102=truncated-cone shaped resistive portion 101 (free edge 110 of the smaller-diameter tube portion 102)+uniaxial aligned tubular non-resistive portion 114 (step portion 104 of the smaller-diameter tube portion), and an outer diameter Ro of the portion of the smaller-diameter tube portion which is between an intermediate section of the truncated-cone shaped resistive portion 101 and the free edge is set larger (refer to FIG. 3) than an inner diameter Ri of an annular folded-back portion 104 of the larger-diameter tube portion. The uniaxial aligned tubular non-resistive portion 114 has a delaying action for generating an additional absorption action later than a primary absorption action. This non-resistive portion 114 is obtained by utilizing the smaller-diameter tube portion 102 as it is which extends from a cross-sectional circular arc-shaped annular folded-back portion of the smaller-diameter tube portion, or by forming a truncated-cone shaped resistive portion 101 so that the this resistive portion 101 extends from a position offset toward the free edge 110.

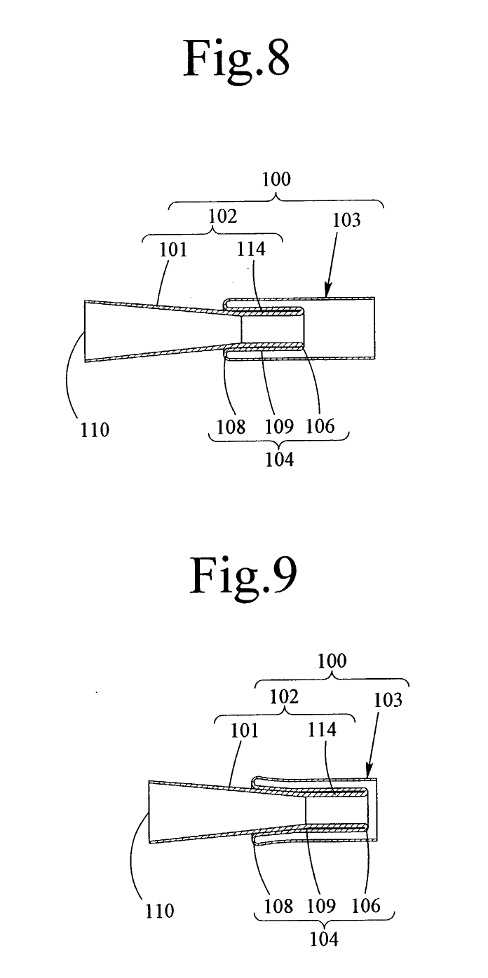

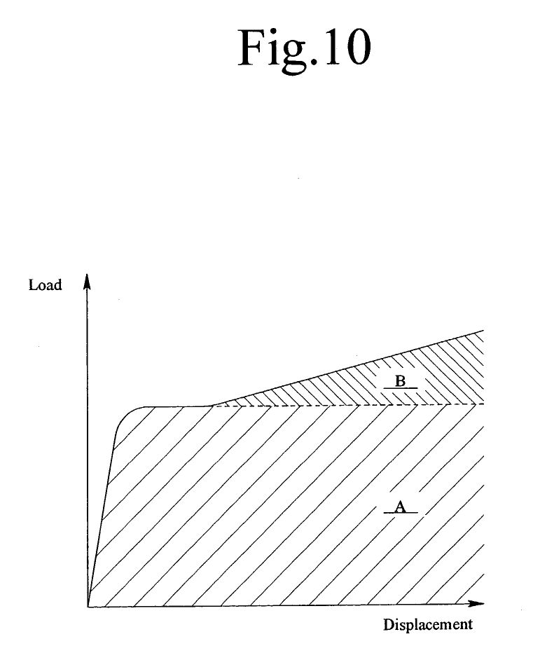

In the resistive-portion-comprised shock absorber in this example, the uniaxial aligned tubular non-resistive portion 114 is first absorbed in the larger-diameter tube portion 103 as seen in FIG. 8. Therefore, an additional absorption action does not occur, and only a primary absorption action in which the larger-diameter tube portion is rolled inward from a cross-sectional circular arc-shaped annular folded-back portion 108 of the larger-diameter tube portion toward a side surface 111 thereof occurs. However, the truncated-cone shaped resistive portion 101 reaches a position of the annular folded-back portion 108 of the larger-diameter tube portion, the diameter of the truncated-cone shaped resistive portion 101 starts increasing via the annular folded-back portion 108 of the larger-diameter tube portion as seen in FIG. 9, so that an additional absorption action occurs temporarily to cause an amount of an energy absorption to increase. Thus, as seen in FIG. 10, the resistive-portion-comprised shock absorber 100 does not differ from the related art resistive-portion-comprised shock absorber 100 until the smaller-diameter tube portion 102 reaches a predetermined volume (sinking amount) of displacement thereof but, after the truncated-cone shaped resistive portion 101 reaches the annular folded-back portion of the larger-diameter tube portion, an additional absorption action increasing temporarily in the same manner as in the previously-described example is generated.

The resistive-portion-comprised shock absorber seen in FIG. 6 is suitable to be utilized in a medium-sized vehicle, for example, a regular automobile. In a medium-sized vehicle, the impact energy at the time of a low-speed collision thereof becomes naturally small as compared with that at such a time of a large-sized vehicle due to the magnitude of mass of the vehicle. Therefore, the displacement-load characteristics demanded at a low-speed collision of a vehicle and those demanded at a high-speed collision thereof are different. In the resistive-portion-comprised shock absorber 100 in which the displacement-load characteristics are divided into the first stage characteristics and latter stage characteristics by providing the uniaxial aligned tubular non-resistive portion 114 therein, only a primary absorption action is generated in the first stage by the sinking of the uniaxial aligned tubular non-resistive portion 114 into the larger-diameter tube portion so as to deal with a low-speed collision of a vehicle, and a primary absorption action and an additional absorption action are generated in the latter stage by the press-inserted of the truncated-cone shaped resistive portion 101 into the larger-diameter tube portion so as to deal with a high-speed collision of the vehicle. Thus, the resistive-portion-comprised shock absorber 100 provided with the uniaxial aligned tubular non-resistive portion 114 is suitable to a case where the displacement-load characteristics at the time of a low-speed collision of a vehicle and those at the time a high-speed collision thereof are rendered different.

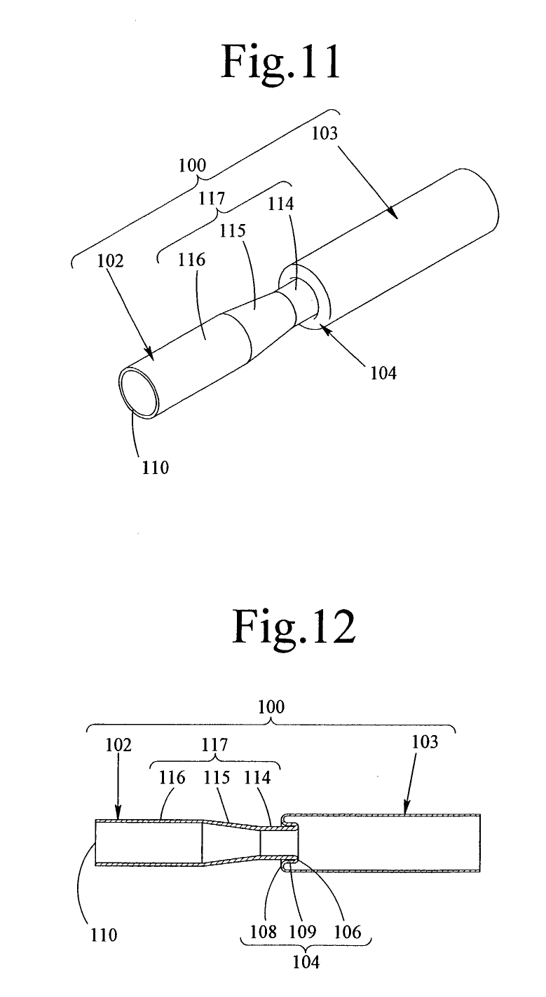

A resistive-portion-comprised shock absorber 100 shown in FIGS. 11 to 16 is an example in which an uniaxial aligned tubular non-resistive portion 114 the outer diameter of which is not larger than the inner diameter of an annular side surface 109 is provided between the restraining type resistive portion 117, which is provided with a side surface 116 of an uniaxial aligned tugular resistive portion joined to a truncated-cone shaped side surface 115 and the annular folded-back portion 106 of the smaller-diameter tube portion.

The resistive-portion-comprised shock absorber 100 seen in FIGS. 11 and 12 is provided with the restraining type resistive portion 117 having an uniaxial aligned tubular non-resistive portion 114 between the restraining type resistive portion 117 and annular folded-back portion 106 of the smaller-diameter tube portion, and a side surface 116 of an uniaxial aligned tubular resistive portion extending from a truncated-cone shaped side surface 115 toward a free edge 110 of the smaller-diameter tube portion 102. Namely, in this example, the smaller-diameter tube portion 102=the restraining type resistive portion 117 (the side surface 116 of the uniaxial aligned tubular resistive portion, the truncated-cone shaped side surface 115 and a part on the side of the free edge 110 of the smaller-diameter tube portion 102)+the uniaxial aligned tubular non-resistive portion 114 (on the side of the step portion 104 of the smaller-diameter tube portion 102), and an outer diameter Ro of the smaller-diameter tube portion is rendered larger (refer to FIG. 3) than an inner diameter Ri of the annular folded-back portion of the larger-diameter tube portion from an intermediate portion of the truncated-cone shaped side surface 115 toward the side surface 116 of the uniaxial aligned tubular non-resistive portion.

The side surface 116 of the restraining type resistive portion 117 has a function of making the truncated-cone shaped side surface 115 cease to expand the larger-diameter tube portion 103 for the purpose of restraining an excessive increase in the diameter of the larger-diameter tube portion 103. Although an amount of the energy absorption is thereby totally increased, variation of an amount of the energy absorption in accordance with a volume of displacement of the smaller-diameter tube portion 102 is set constant (variation on a graph of the displacement-load characteristics is constant).

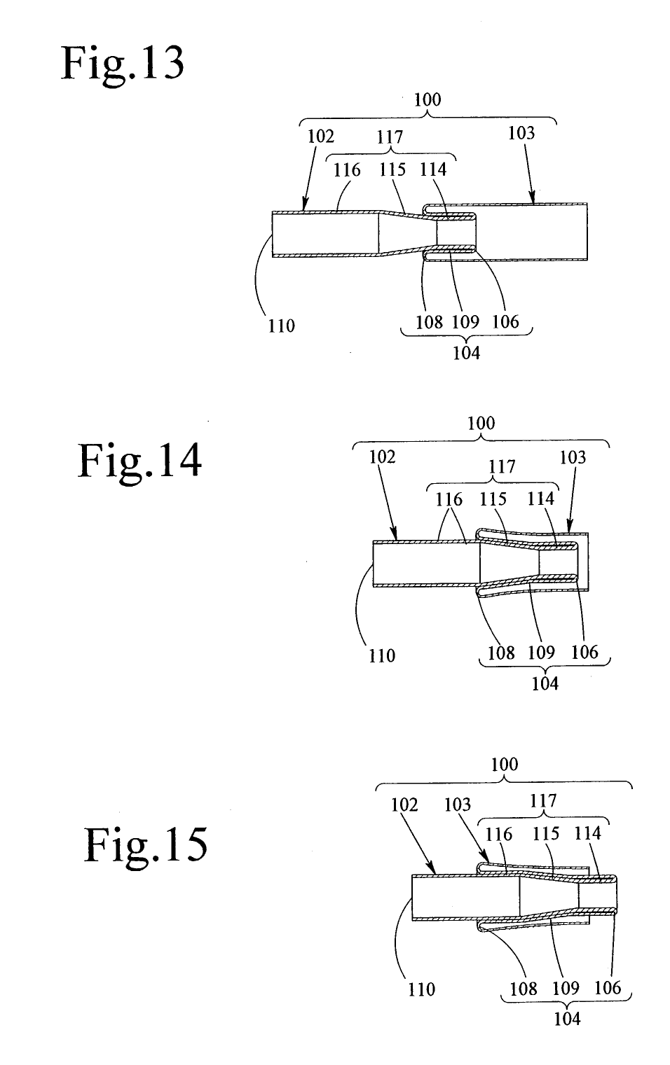

To be concrete, as seen in FIG. 13, an additional absorption action does not occur in stage in which the uniaxial aligned tubular non-resistive portion 114 is absorbed in the larger-diameter tube portion 103, and only a primary absorption action in which the larger-diameter tube portion rolls round inward from the annular folded-back portion 108 toward the larger-diameter tube portion side surface 111 occurs. However, when the truncated-cone shaped side surface 115 of the subsequent restraining type resistive portion 117 reaches the annular folded-back portion 108 of the larger-diameter tube portion, the truncated-cone shaped side surface 115 starts expanding the larger-diameter tube portion 103 via the annular folded-back portion 108 of the larger-diameter tube portion as seen in FIG. 14, and an additional absorption action for increasing the diameter of the larger-diameter tube portion in accordance with a sinking amount of the smaller-diameter tube portion 102 is generated.

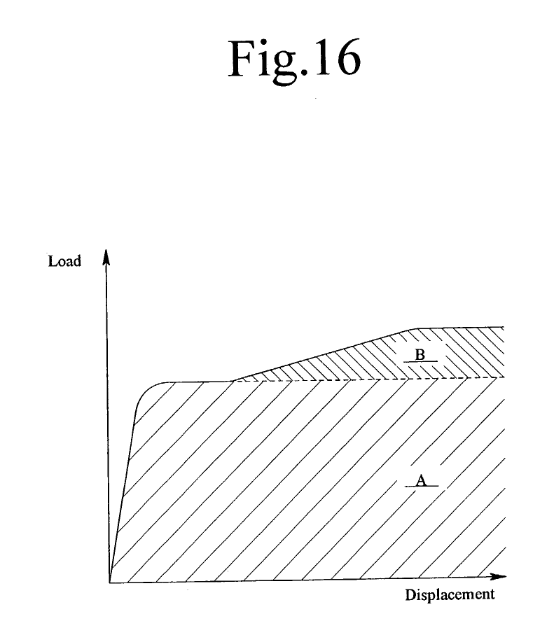

When the uniaxial aligned tubular resistive portion side surface 116 of the restraining type resistive portion 117 reaches the annular folded-back portion 108, a predetermined press-inserted state by an outer circumference of the uniaxial aligned tubular resistive portion side surface 116 as seen in FIG. 15, and a predetermined additional absorption action which is not proportional to the sin-king amount of the smaller-diameter tube portion 102 keeps being made. The displacement-load characteristics of this example draw a graph seen in FIG. 16, and it is understood from the results of a comparison between these characteristics and those of the resistive-portion-comprised shock absorber 100 (FIG. 6 onward) described in a previous example that the characteristics are characteristics in which an upper limitation is placed on the additional absorption action.

The resistive-portion-comprised shock absorber 100 seen in FIG. 11 is suitable to be utilized in a small-sized vehicle, for example, a light automobile. In a small-sized vehicle, impact energy at the time of a low-speed collision thereof is small just as that in the above-mentioned medium-sized vehicle, so that it is desirable that the displacement-load characteristics at the time of a low-speed collision of a vehicle and those at the time of a high-speed collision thereof be set different. In addition, in a small-sized vehicle, the strength of a vehicle body is low, and the displaying of an additional absorption action limitlessly cannot be done. Therefore, the resistive-portion-comprised shock absorber 100 provided as in this example with an upper limit on the occurrence of an additional absorption action is preferable. This enables the transmission of a shock to occupants of a vehicle to be restrained or prevented by placing a limitation on the amount of the energy absorption as a primary absorption action only and both a primary absorption action and an additional absorption action are generated at the time of a low-speed collision thereof and at the time of a high-speed collision thereof respectively.

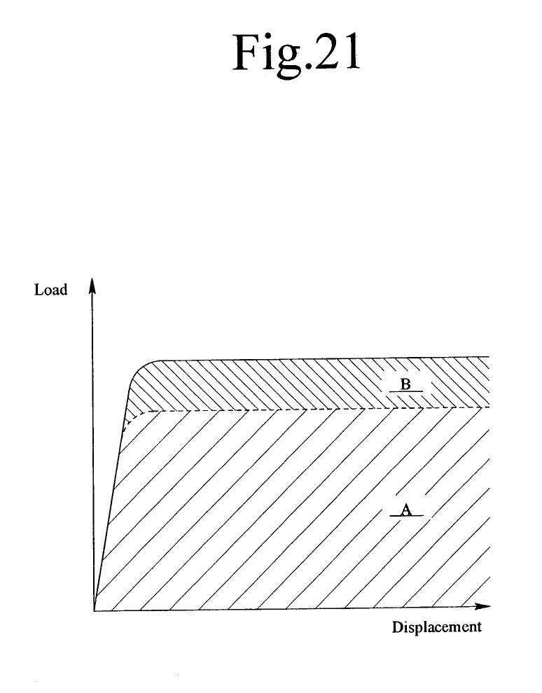

A resistive-portion-comprised shock absorber 100 shown in FIGS. 17 to 21 is an example of the resistive-portion-comprised shock absorber 100 including a smaller-diameter tube portion 102 provided with an uniaxial aligned tubular resistive portion 113 and a larger-diameter tube portion 103.

In all of the above-described examples (refer to FIGS. 1, 6 and 11), a restraining type resistive portion 117 having a truncated-cone shaped resistive portion 101 or a truncated-cone shaped side surface 115 was used, and an additional absorption action increasing in proportion to an amount of sinking of a smaller-diameter tube portion 102 with respect to a larger-diameter tube portion 103 was generated. In the resistive-portion-comprised shock absorbers 100 shown in FIGS. 17 to 21 onward, an additional absorption action which does not have relation with a volume of displacement of the smaller-diameter tube portion 102 is generated so that a primary absorption action is increased (offset in the direction in which an amount of the impact energy absorption increases) by a predetermined amount as a whole.

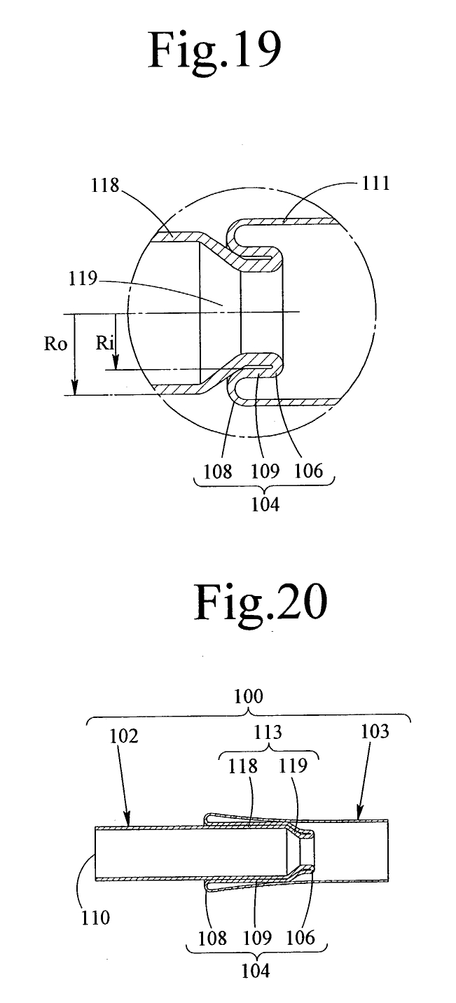

In the resistive-portion-comprised shock absorber 100 seen in FIGS. 17 and 18, an uniaxial aligned tubular resistive portion 113 having a side surface 118 of the uniaxial aligned tubular resistive portion expanded to an outer diameter Ro (refer to FIG. 19) of the smaller-diameter tube portion which is larger than an inner diameter Ri of a cross-sectional circular arc-shaped annular folded-back portion of the larger-diameter tube portion is formed so as to extend from a step portion 104 toward a free edge 110. To be concrete, the uniaxial aligned tubular resistive portion 113 includes a side surface 118 of the uniaxial aligned tubular resistive portion, and a resistive front ring 119 rising from a cross-sectional circular arc-shaped annular folded-back portion of the smaller-diameter tube portion in the tangential direction of a cross-sectional circular arc-shaped annular folded-back portion 108 of the larger-diameter tube portion. When the smaller-diameter tube portion 102 in such a resistive-portion-comprised shock absorber 100 starts being absorbed in the larger-diameter tube portion 103 therein, the resistive front ring 119 immediately expands the step portion 104 as seen in FIG. 20, and an additional absorption action, i.e. an action of expanding the larger-diameter tube portion 103 in proportion to the outer diameter of the side surface 118 of the uniaxial aligned tubular resistive portion is generated.

A rate of the expansion operation for the larger-diameter tube portion 103 by the uniaxial aligned tubular resistive portion 113 is limited to that determined by the outer diameter of the side surface 118, so that the additional absorption action becomes constant. Therefore, the displacement-load characteristics form a graph of a primary absorption action (A region) plus an additional absorption action (B region), i.e. a graph in which a portion offset by an additional absorption is added. Such a resistive-portion-comprised shock absorber 100 can be applied widely to a small-sized vehicle to a large-sized vehicle with an amount of the energy absorption in which an additional absorption action is added to a primary absorption action set as an upper limit. Since the resistive-portion-comprised shock absorber 100 in this example is capable of setting an amount of the energy absorption largest, the shock absorber has the advantage of reducing a total length and attaining a smaller weight thereof.

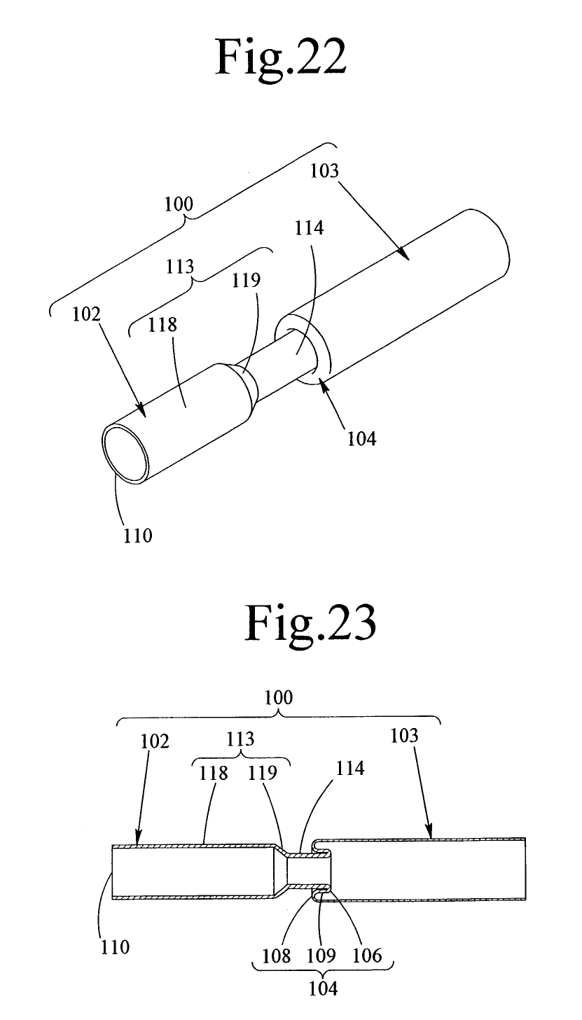

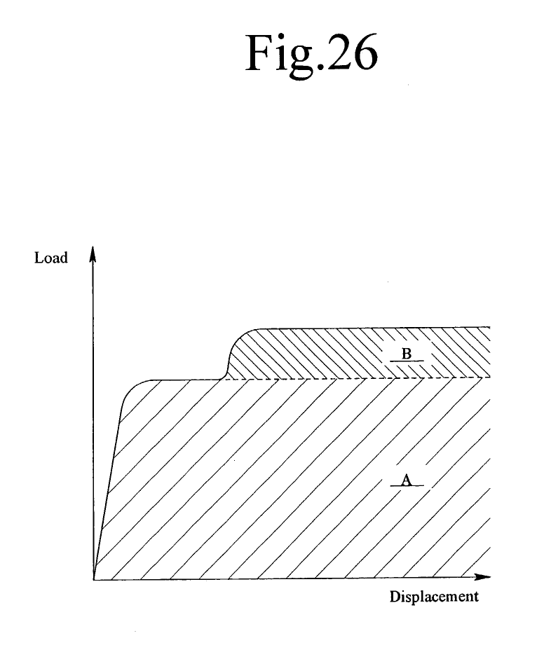

A resistive-portion-comprised shock absorber 100 shown in FIGS. 22 to 26 is an example provided with an uniaxial aligned tubular non-resistive portion 114, the outer diameter of which is not greater than the inner diameter of an annular side surface 109, between the same uniaxial aligned tubular resistive portion 113 and annular folded-back portion 106 of the smaller-diameter tube portion as shown above. When the uniaxial aligned tubular non-resistive portion 114 is interposed between the uniaxial aligned tubular resistive portion 113 and the step portion 104, a delay action for delaying the occurrence of the additional absorption action can be added.

The resistive-portion-comprised shock absorber 100 seen in FIGS. 22 and 23 has an uniaxial aligned tubular resistive portion 113 which includes a side surface 118 obtained by increasing an outer diameter of a smaller-diameter tube portion 102 to a level higher than that of an inner diameter Ri of a cross-sectional circular arc-shaped annular folded-back portion of a larger-diameter tube portion, and which is formed so as to extend toward a free edge 110 of the smaller-diameter tube portion 102. This shock absorber is also provided with an uniaxial aligned tubular non-resistive portion 114 the outer diameter of which is not larger than the inner diameter of an annular side surface 109. The uniaxial aligned tubular resistive portion 113 is formed by a side surface 118, and a resistive front ring 119 rising acutely from the uniaxial aligned tubular non-resistive portion 114. A rising angle of the resistive front ring 119 may be not smaller than 45 degrees, and is preferably set to 80 to 90 degrees.

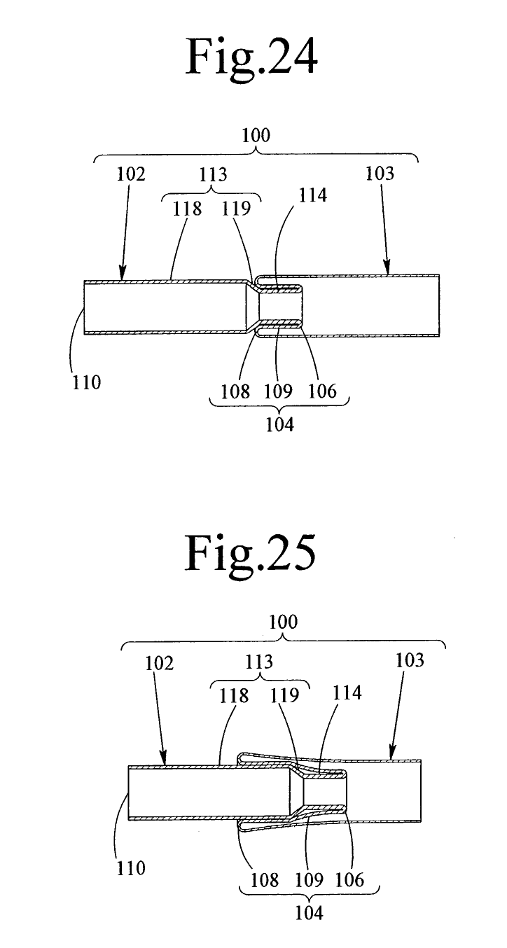

When the smaller-diameter tube 102 in this resistive-portion-comprised shock absorber 100 starts being absorbed in the larger-diameter tube portion 103, first the uniaxial aligned tubular non-resistive portion 114 is absorbed in the larger-diameter tube portion 103 as seen in FIG. 24, and only a primary absorption action occurs. However, when the resistive front ring 119 reaches the annular folded-back portion 108 of the larger-diameter tube portion to cause the uniaxial aligned tubular resistive portion 113 to start being press-inserted into the larger-diameter tube portion 103 as seen in FIG. 25, the resistive front ring 119 expands a step portion 104 to cause an additional absorption action to be newly generated.

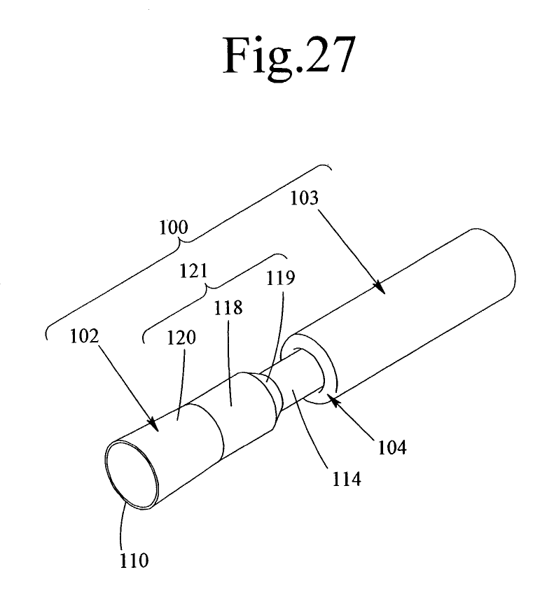

The generation of an additional absorption action occurring in a stepped manner with respect to a primary absorption action can also be regarded as displacement-load characteristics representing the occurrence of delayed additional absorption action (B region) with respect to a preceding primary absorption action (A region). This resistive-portion-comprised shock absorber 100 suits small-sized to medium-sized vehicles which demand displacement-load characteristics different at the time of a low-speed collision of a vehicle and at the time of a high-speed collision thereof with an amount of energy absorption, which is obtained by adding an additional absorption action to a primary absorption action, set as an upper limit. When a reinforcing resistive portion 121 having a truncated-cone shaped side surface 120 is provided (refer to FIG. 27 which is a perspective view corresponding to FIG. 1 of the resistive-portion-comprised shock absorber provided with the reinforcing resistive portion 121) as necessary in the smaller-diameter tube portion 102 so that this reinforcing resistive portion 121 continues from the side surface 118 of the uniaxial aligned tubular resistive portion 113, the shock absorber can also be applied to a large-sized vehicle.

The resistive-member-mounted shock absorber according to the present invention will now be described with reference to the drawings.

A first example is a shock absorber having a structure in which a rigid ring member (metal ring) 201 an outer diameter of which is smaller than an inner diameter Ri (shown as a radius in each drawing) of a larger-diameter tube portion, and an inner diameter of which is larger than an outer diameter Ro (shown as a radius in each drawing) of a cross-sectional circular arc-shaped annular folded-back portion of a smaller-diameter tube portion, is inserted in the interior of a larger-diameter tube portion 202 in a resistive-member-mounted shock absorber 200.

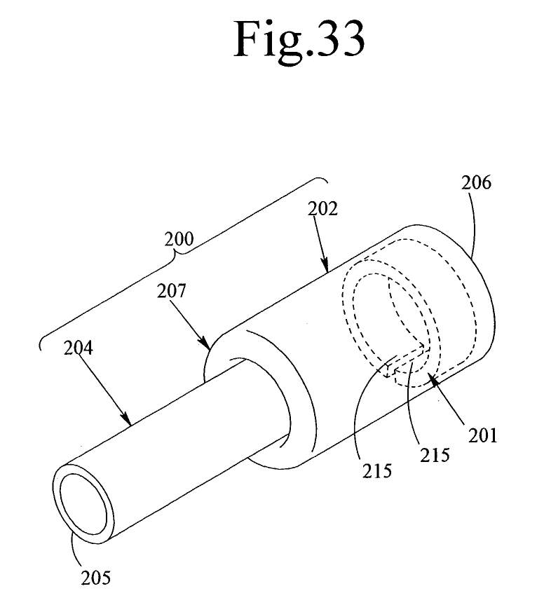

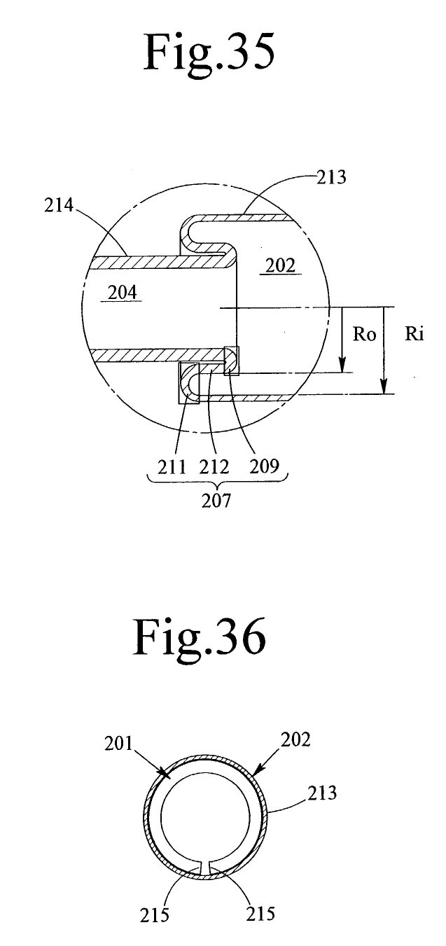

First, constituent portions of the resistive-member-mounted shock absorber 200 common to the examples including this example onward will be described. Each resistive-member-mounted shock absorber 200 is based on a structure formed by contracting a front stage (or expanding a rear stage) of a plastic-deformable straight metal tube, and thereby forming the front stage as a smaller-diameter tube portion 204 and the rear stage as a larger-diameter tube portion 202, the larger-diameter tube portion 202 housing therein a resistive member (a rigid ring member 201 is inserted in the larger-diameter tube in the examples of FIG. 33 onward). A bumper structural member (not shown) is connected to a free edge 205 of the smaller-diameter tube portion 204, and a vehicle body member (not shown) to a rear edge 206 of the larger-diameter tube portion 202, the resistive-member-mounted shock absorber 200 being formed so that the shock absorber 200 supports the bumper structural member with respect to the vehicle body member. As shown in FIG. 35, a step portion 207 has a sectional structure formed by connecting together by an annular side surface 212 made of a straight tube side surface, a cross-sectional circular arc-shaped annular folded-back portion 209 of the smaller-diameter tube portion with an arc-shaped cross section obtained by folding back a side surface 214 of the smaller-diameter tube portion, and a cross-sectional circular arc-shaped annular folded-back portion 211 of the larger-diameter tube portion with an arc-shaped cross section obtained by folding back a side surface 213 of a larger-diameter tube portion. The smaller-diameter tube portion 204 is displaced toward and absorbed in the larger-diameter tube portion 202 due to an impact received at a free edge 205 of the smaller-diameter tube portion 204 via the bumper structure.

The annular side surface 212 restrains or prevents the inclination of the smaller-diameter tube portion 204 when an impact is applied to the smaller-diameter tube portion in the diagonal direction, and forces the smaller-diameter tube portion 204 to sink into the larger-diameter tube portion 202 while correcting the inclination of the smaller-diameter tube portion. When the smaller-diameter tube portion 204 in the resistive-member-mounted shock absorber 200 is absorbed in the larger-diameter tube portion 202, plastic deformation (primary absorption action) in which the larger-diameter tube portion is rolled round inward from the annular folded-back portion 211 thereof toward the side surface 213 thereof occurs to absorb the impact energy as the energy of the plastic deformation mentioned above. A mode in which the smaller-diameter tube portion is rolled round outward from the annular folded-back portion of the smaller-diameter tube portion toward the side surface thereof is also conceived as a mode of the mentioned plastic deformation. However, in the smaller-diameter tube portion 204 and larger-diameter tube portion 202 formed by partially reducing or partially enlarging a straight tube, the thickness of a side surface 213 of the larger-diameter tube portion 202 is relatively smaller than that of the side surface 214 of the smaller-diameter tube portion 204, so that the plastic deformation of the larger-diameter tube portion, i.e. the rolling of the larger-diameter tube portion from the annular folded-back portion 211 thereof toward the side surface 213 occurs more easily. The advantages of the rolling of the larger-diameter tube portion side surface are as mentioned above.

In order to reliably generate plastic deformation in which the larger-diameter tube portion rolls round from the annular folded-back portion 211 of the larger-diameter tube portion toward the side surface 213 thereof in each example, the step portion 207 have a sectional structure in which the annular folded-back portion 209 of the smaller-diameter tube portion made of an arc-shaped cross section of an arc angle of substantially 180 degrees and the annular folded-back portion 211 of the larger-diameter tube portion are connected together with a radius of the arc-shaped cross section of the annular folded-back portion 209 of the smaller-diameter tube portion set (refer to FIG. 35) relatively small as compared with that of the annular folded-back portion of the larger-diameter tube portion. Therefore, when the smaller-diameter tube portion receives an impact, the annular folded-back portion 209, at which the tube is folded back relatively acutely, of the smaller-diameter tube portion is rarely plastically deformed, and the annular folded-back portion 211 made of a relatively gently continuing arc-shaped edge is plastically deformed to thereby cause a primary absorption action to occur reliably.

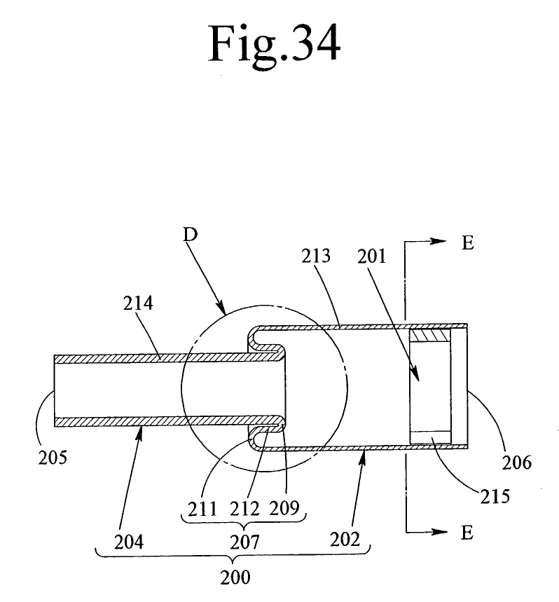

As seen in FIGS. 33 and 34, the resistive member in this example includes a rigid ring member (metal ring) 201 the outer diameter of which is smaller than the inner diameter Ri of the larger-diameter tube portion, and the inner diameter of which is larger than the outer diameter Ro of the annular folded-back portion of the smaller-diameter tube portion. This rigid ring member 201 has a structure formed by rolling a plate material of a comparatively large thickness to an annular shape, and, as seen in FIG. 36, end portions 215, 215 of the plate material are left separated from each other and not joined to each other. Therefore, when the rigid ring member 201 is contracted so as to bring the end portions 215, 215 of the plate material close to or into contact with each other, the rigid ring member 201 can be inserted easily into the interior of the larger-diameter tube portion 202. Even when the outer diameter of this rigid ring member 201 is substantially equal to the inner diameter Ri of the larger-diameter tube portion with the inner diameter of the rigid ring member 201 greater than the outer diameter Ro of the annular folded-back portion of the smaller-diameter tube portion, the rigid ring member can be press-inserted easily into the interior of the larger-diameter tube portion as long as the above-mentioned end portions 215, 215 in a separated state are provided in the above-mentioned manner.

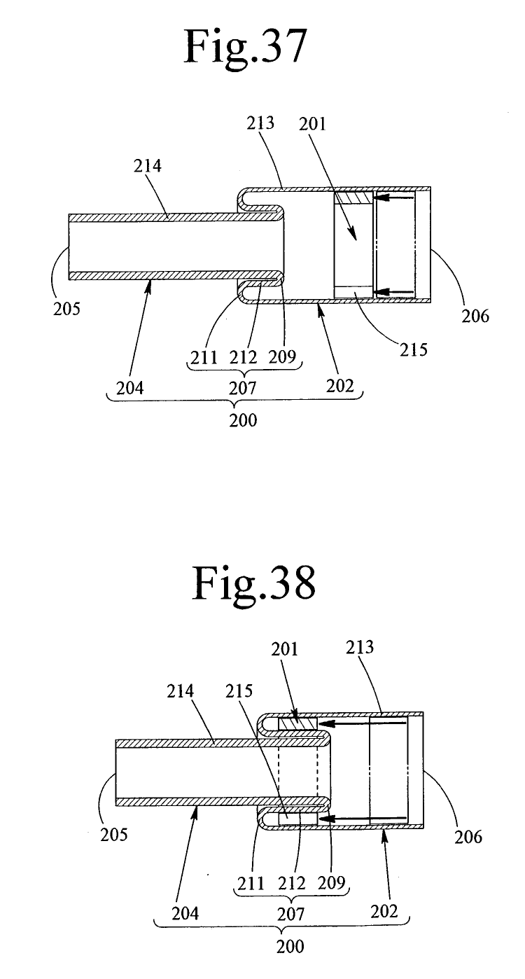

When an automobile receives an impact, the impact is transmitted to the smaller-diameter tube portion 204 via the bumper structure to cause plastic deformation in which the larger-diameter tube portion rolls round from the annular folded-back portion 211 of the larger-diameter tube portion in the step portion 207 toward the side surface 213 of the larger-diameter tube portion to occur, and the resistive-member-mounted shock absorber 200 absorbs the impact energy. During this time, the speed of the automobile is low in many cases when a low-speed collision of the automobile occurs, and the shock is small. Therefore, as seen in FIG. 37, the measurement of sinking of the smaller-diameter tube portion 204 with respect to the larger-diameter tube portion being plastically deformed is small, and the amount of a forward movement, which is based on an inertial force, of the rigid ring member 201 inserted in the larger-diameter tube portion is also not large. Therefore, the smaller-diameter tube portion 204 absorbs the impact energy by only the plastic deformation of the shock absorber without being influenced by the speed reducing action and sinking restraining action (in the case of the rigid ring member 201) of the rigid ring member 201.

However, at the time of a high-speed collision of a vehicle, an impact becomes large. Therefore, as seen in FIG. 38, the measurement of sinking of the smaller-diameter tube portion 204 with respect of the larger-diameter tube portion 202 being plastically deformed is large, and the amount of a forward movement, which is based on an inertial force, of the rigid ring member 201 inserted in the larger-diameter tube portion 202 also becomes large. Under the circumstances, the rigid ring member 201 reaches the step portion 207 which generates plastic deformation, and a speed reducing action and a sinking restraining action (in the case of the press-inserted rigid ring member 201) of the rigid ring member 201 are made, so that the sinking of the smaller-diameter tube portion 204 receives the resistance of the rigid ring member 201. This resistance does not obstruct the rolling, which occurs during the plastic deformation of the portion of the larger-diameter tube portion which is between the annular folded-back portion 211 thereof and the side surface 213 thereof since the inner diameter of the rigid ring member 201 is larger than the outer diameter Ro of the annular folded-back portion of the larger-diameter tube portion. The resistance is based on the friction occurring due to the rigid ring member 201 sandwiched between the side surface 213 of the larger-diameter tube portion and the annular side surface 212. Therefore, when the rigid ring member 201 is in a press-inserted state from the first, in which friction occurs with respect to the side surface 213 of the larger-diameter tube portion, a sinking restraining action comes to be displayed more distinctly as the resistance with respect to the sinking of the smaller-diameter tube portion 204 into the larger-diameter tube portion.

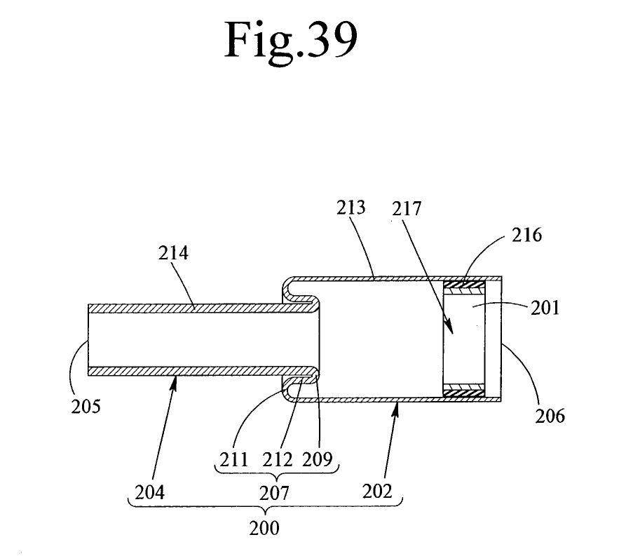

The differences in the modes of inserting or press-inserted of the rigid ring member 201 (and other ring) with respect to the larger-diameter tube portion come to appear as differences in the speed of the rigid ring member at the time of collision of a vehicle at which the rigid ring member 201 can be moved in accordance with the inertia, as differences in the amount of a forward movement of the rigid ring member during a movement thereof, and as variation of the degree of resistance to the sinking of the smaller-diameter tube portion 204 due to the rigid ring member 201. When the friction of the rigid ring member 201 does not normally occur (except the friction of the rigid ring member 201 due to the partial contact thereof with the side surface 213) with respect to the side surface 213 of the larger-diameter tube portion 201, the rigid ring member 201 as a resistive member comes to display mainly a speed reducing action as an obstructive element for the plastic deformation needed for the sinking of the smaller-diameter tube portion 204 into the larger-diameter tube portion 202. On the other hand, when the rigid ring member 201 is press-inserted in the larger-diameter tube portion 202, the friction necessarily occurring during a movement of the rigid ring member 201 increases in proportion to the moving speed of the smaller-diameter tube portion 204, so that a sinking restraining action comes to be displayed. The degree and ratio of such a speed reducing action or a sinking restraining action are swayed by the raw material for and the construction of the resistive-member-mounted shock absorber 200 and the raw material for and the construction or constitution of the rigid ring 201. Therefore, these raw materials and construction or constitution may be determined suitably in accordance with the needed shock absorption performance. For example, when it is desired that the frictional force of the ring be increased, an elastic ring member may be used, or a structure in which a dual structural ring member 217 having an elastic ring member 216 in an outer circumferential portion of the rigid ring member is press-fitted in the larger-diameter tube portion 202 as shown in FIG. 39 (corresponding to FIG. 34 of the resistive-member-mounted shock absorber 200 in which a resistive member is formed by inserting, or press-inserted, the ring member 217 in the interior of the larger-diameter tube portion 202) may be employed.

Basically, each of the above-described ring members is merely inserted in the interior of the larger-diameter tube portion. When the ring member is moved forward due to the vibration of an automobile even though the ring member does not receive a particular impact, the ring member cannot be returned to an initially set position. In order to prevent a movement of the ring member in a case other than the case where the ring member thus receives an impact, it is preferable to press-insert a ring member into the interior of the larger-diameter tube portion so that the ring member is not moved forward due to vibration.

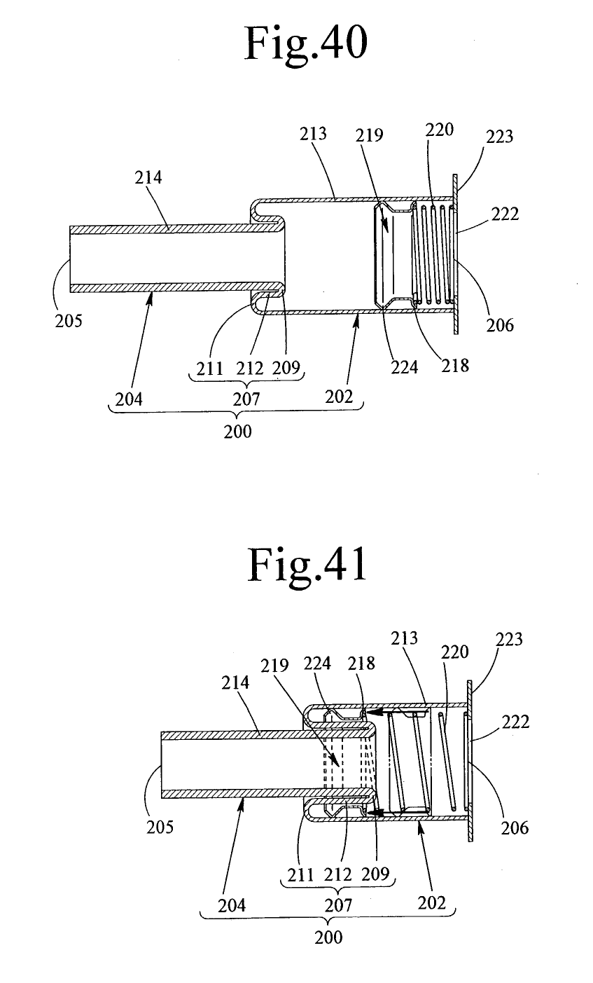

In order to prevent the movement of the ring member more positively, a backward movement preventing stopper with which the ring member is engaged fixedly is provided in the interior of the larger-diameter tube portion, or the rigid ring member 219 may be formed by a resistive member of a structure in which the rigid ring member is supported on the coiled spring 220 as seen in FIG. 40. In this example, a support plate 223 provided with a hole 222 into which the smaller-diameter tube portion 204 is sunk is fixed to a rear edge 206 of the larger-diameter tube portion 202, and the coiled spring 220 connects together the rear edge of the rigid ring member 219 and the support plate 223. Therefore, when the coiled spring 220 is expanded or compressed due to vibration, this coiled spring generates a restoring force, so that the rigid ring member 219 can be returned to the initially set position (position of the rigid ring member 219 seen in FIG. 40).

The coiled spring 220 works so as to prevent the forward movement, which is caused by an impact, of the rigid ring member 219, and also has a role of heightening a level of an impact at which a speed reducing action and a sinking restraining action with respect to the sinking of the smaller-diameter tube portion 204 by the force of the rigid ring member 219 are displayed. Reversely stating, when an impact exceeding the restoring force of the coiled spring 220 is imparted to the smaller-diameter tube portion, the rigid ring member 219 is moved forward to reach the step portion 207 as seen in FIG. 41, and displays as a resistive member a speed reducing action and a sinking restraining action with respect to the sinking of the smaller-diameter tube portion 204.

The rigid ring member 219 in this example is formed by plastically processing a metal tube having a small wall thickness, and provided at a front side (smaller-diameter tube portion side) thereof with a sliding-contact annular portion 224 for preserving its position, and at a rear side (larger-diameter tube portion side) thereof with a hooking annular portion 218 engaged with the coiled spring 220 in the receding direction toward the side surface 213 of the larger-diameter tube portion. The hooking annular portion 218 gives directivity to the generation of friction, generates friction only when the rigid ring member 219 moves back in accordance with the sinking of the smaller-diameter tube portion 204 into the larger-diameter tube portion, and displays a sinking restraining action. In the rigid ring member 219 in this example, which has the sliding-contact annular portion 224 and hooking annular portion 218, such a complicated constitution brings about the improvement in the strength of the structure. Therefore, even the structure of a thin metal plate like that in this example is neither overcome by the pressure occurring during the plastic deformation of the smaller-diameter tube portion nor deformed.

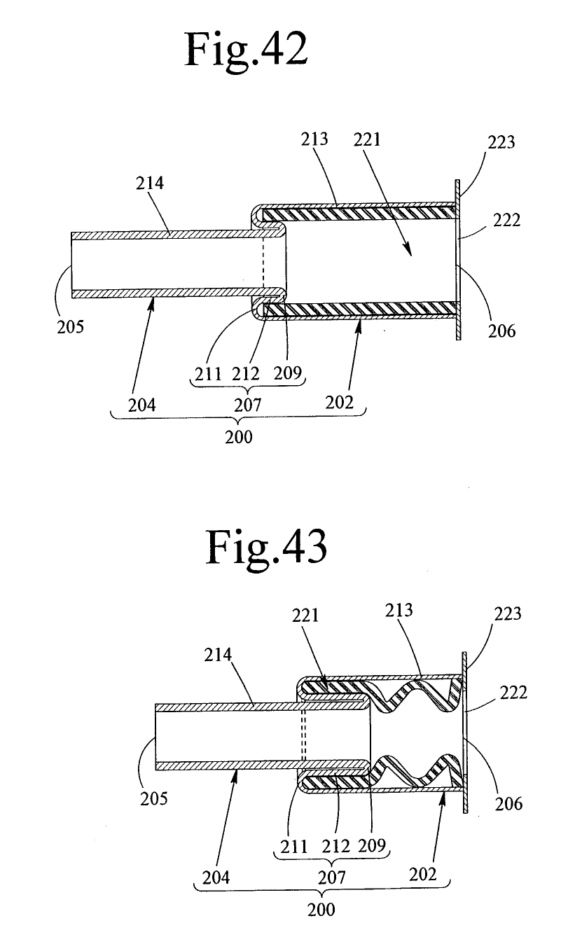

The resistive member can also be formed even when a ring member moving in the interior of the larger-diameter tube portion is not employed. For example, as seen in FIG. 42, there is a resistive member formed by fixing a support plate 223, which is provided with a hole 222 into which the smaller-diameter tube portion is absorbed, to a rear edge 206 of a larger-diameter tube portion, and inserting, or press-inserted, an elastic annular member (elastic tube) 221, which extends from a cross-sectional circular arc-shaped annular folded-back portion 211 of a step portion 207 to the support plate 223, into the interior of a larger-diameter tube portion 202. This elastic annular member 221 is held between the step portion 207 and support plate 223 and positioned fixedly. In order that the elastic annular member 221 be held more stably in the interior of the larger-diameter tube portion, the elastic annular memeber 221 may be bonded to a side surface of the larger-diameter tube portion. Since this elastic annular member 221 already reaches at a free end thereof the step portion 207 in an initial condition thereof, a speed reducing action (friction on the side surface 213) and a sinking restraining action (compression or deformation of the elastic annular member 221) come to be displayed even at the time of a low-speed collision of a vehicle.

When the measurement of sinking of the smaller-diameter tube portion 204 increases, the compression and a very little deformation only of the elastic annular member 221 do not display a sufficient sinking-restraining effect, and, as shown in FIG. 43, the elastic annular member 221 is deformed greatly, i.e., starts displaying a high sinking restraining action. A deformation region for the elastic annular member 221 is defined by the step portion 207, the support plate 223 and the side surface 213, so that there is a limit to the deformation region. As the deformation of the elastic annular member 221 comes closer to the limit, the sinking restraining action is displayed powerfully. When the impact energy applied to the smaller-diameter tube portion exceeds a limit of the deformation energy, an excess load is used as a “shearing force” in the step portion 207. Since the shearing force in the step portion 207 is generally larger than a force needed for the plastic deformation occurring in the step portion, a larger amount of absorption of energy can be secured.

Both of the resistive-portion-comprised shock absorber and the resistive-member-mounted shock absorber according to the present invention have an effect of easily satisfying the displacement-load characteristics demanded on the basis of different conditions of a small-sized vehicle, a medium-sized vehicle, and a large-sized vehicle, and a low-speed collision or a high-speed collision of a vehicle.

Concrete descriptions of the individual shock absorbers will now be given. The resistive-portion-comprised shock absorber has the following effects. In, for example, a small-sized vehicle, an upper limit is need for an amount of impact energy absorption increasing. This upper limit can be set by using restraining type resistive portions including a truncated-cone shaped side surface and an uniaxial aligned tubular non-resistive portion, and an uniaxial aligned tubular resistive portion. A medium-sized vehicle may have displacement-load characteristics having different absorption quantities of energy occurring at the time of low-speed and high-speed collisions of a vehicle, i.e., the providing of a non-resistive portion between a resistive portion and a step portion, and the using of a reinforcing resistive portion may be done. In a large-sized vehicle, a truncated-cone shaped resistive portion the amount of the energy absorption of which increases in accordance with the volume of displacement of a smaller-diameter tube portion, and a reinforcing type resistive portion may be used since there is not an upper limit of an amount of the energy absorption.

The displacement-load characteristics can be regulated easily by providing a suitably combined resistive portion and a non-resistive portion in a smaller-diameter tube portion. According to this invention, the number of stages of the smaller-diameter tube portion and the larger-diameter tube portion can be further increased with a structure having one smaller-diameter tube portion and one larger-diameter tube portion used as a basic structure. When combinations of such basic structures are added, the regulatable displacement-load characteristics come to further increase. Each resistive portion and non-resistive portion can be formed easily by a plastic processing in which the diameter of a basic straight tube is reduced or enlarged. This enables the resistive-portion-comprised shock absorber according to the present invention to be manufactured to small weight, by a comparatively simple processing method utilizing the plastic deformation of the smaller-diameter tube portion, and at a low price. Besides these, a smaller-diameter tube portion provided with a resistive portion is expanded at a free edge thereof in consequence, and has the effect of heightening the bonding strength of a bumper structure member connected to the same free edge, increasing the bending resistance of the smaller-diameter tube portion when an impact is applied thereto in the diagonal direction, and improving the performance of the bumper structure member as a support member.

The resistive-member-mounted shock absorber provides a shock absorber capable of setting suitable displacement-load characteristics on the basis of a difference in the vehicle speed at the time of collision thereof, this shock absorber having effects of suitably absorbing the impact energy in accordance with various modes of shocks, and preventing or restraining the transmission of an impact to occupants of a vehicle. The amount of the energy absorption increasing effect was practically obtained by such various types of resistive members as mentioned above provided in the larger-diameter tube portion. Simply speaking, when a rigid or elastic or both of ring members formed independently of the shock absorber is inserted or press-inserted in the interior of the larger-diameter tube portion, each ring member obstructs the plastic deformation of the tube portion in the step portion, and increases an amount of the energy absorption.

The effect of rendering it possible to selectively display an increase in the amount of the energy absorption on the basis of a speed difference at the time of a collision of a vehicle is obtained so that the generation of a deformation speed reducing action or a tube portion sinking restraining action by a resistive member becomes different on the basis of a difference in the sinking speed or sinking amount of the smaller-diameter tube portion with respect to the larger diameter tube portion, modes of collisions of a vehicle to be exact, which include a low-speed collision and a high-speed collision. For example, related art shock absorbers (disclosed in, for example, Japanese Patent No. 47-014535 and U.S. Pat. No. 3,599,757) provided with a ring member, and a ring member similar to the mentioned ring member and housed in a larger-diameter tube portion so as to restrain the deformation of a step portion is seen. However, the ring member in these related art shock absorbers is fixed to the interior of a larger-diameter tube portion, and has nothing but a function of merely determining a mode of plastic deformation of the larger-diameter tube portion. According to the present invention, the ring member is inserted or press-inserted in the interior of the larger-diameter tube portion so that the ring member can be moved freely therein. As a result, a deformation speed reducing action and a tube portion sinking restraining action with respect to the smaller-diameter tube portion are added continuously with respect to a region of collision of a vehicle between a low-speed collision of a vehicle and a high-speed collision thereof, or additionally with respect to a region of a high-speed collision of a vehicle with respect to a region of a low-speed collision thereof. Thus, an effect of practically obtaining object different displacement-load characteristics based on a difference between a low-speed collision of a vehicle and a high-speed collision thereof is obtained.

The resistive-member-mounted shock absorber according to the present invention thus attains the obtainment of displacement-load characteristics that are different with respect to a low-speed collision of a vehicle and a high-speed collision thereof, so that a shock absorber adapted to suitably absorb impact energy with respect to various modes of collision of a vehicle can be provided.

What is claimed is:

1. A shock absorber comprising:
a smaller-diameter tube portion and a larger-diameter tube portion integrally formed by partially reducing or partially enlarging a straight tube that can be plastically deormable, and
a step portion formed continuously between edge of the smaller-diameter tube portion and the larger-diameter tube portion by being folded the edge back to the each tube portions, wherein
a frictional resistive portion is provided to the smaller-diameter tube portion sliding into the larger-diameter tube portion in order to control an amount of absorption of impact energy applied.

2. A shock absorber according to claim 1, wherein the step portion comprises a sectional structure in which a cross-sectional circular arc-shaped annular folded-back portion of the smaller-diameter tube portion having a smaller radius of curvature in a cross section thereof, a cross-sectional circular arc-shaped annular folded-back portion of the larger-diameter tube portion having a larger radius of curvature in a cross section thereof, an annular side surface being to join edges of the annular folded-back portions through edges thereof, and thereby forming the step portion in S-shaped cross section integrally.

3. A shock absorber according to claim 1, wherein the frictional resistive portion is provided to a side surface of the smaller-diameter tube portion which is shaped in a truncated cone obtained by gradually enlarging an outer diameter of the smaller-diameter tube portion from the step portion toward a free edge of the smaller-diameter tube portion until the outer diameter becomes larger than an inner diameter of the annular folded-back portion of the larger-diameter tube portion.

4. A shock absorber according to claim 1, wherein the frictional resistive portion is provided to the side surface of the smaller-diameter tube portion having an outer diameter being larger than the inner diameter of the annular folded-back portion of the larger-diameter tube portion as an enlarged straight tube.

5. A shock absorber according to claim 1, wherein the frictional resistive portion is provided to the smaller-diameter tube portion having a combined shape with the truncated cone portion obtained by enlarging the outer diameter thereof gradually from the step portion toward the free edge thereof until the outer diameter becomes larger than the inner diameter of the annular folded-back portion of the larger-diameter tube portion and the straight tube portion integrally extending from an edge of the truncated cone portion.

6. A shock absorber according to claim 1, wherein the frictional resistive portion is further provided to the smaller-diameter tube portion having a combined shape with the straight tube portion enlarged the outer diameter of the smaller-diameter tube portion larger than the inner diameter of the annular folded-back portion of the larger-diameter tube portion and the truncated cone portion obtained by integrally enlarging the outer diameter gradually from the straight tube portion toward the free edge thereof.

7. A shock absorber according to claim 1, wherein the smaller-diameter tube portion comprises a non-frictional resistive portion having the outer diameter less than the inner diameter of the annular folded-back portion of the larger-diameter tube portion, provided between the annular folded-back portion of the smaller-diameter tube portion and the frictional resistive portion.

8. A shock absorber comprising:
the smaller-diameter tube portion and the larger-diameter tube portion which are integrally formed by partially reducing or partially enlarging the straight tube that can be plastically deformable, and
the step portion formed continuously between the edge of the smaller-diameter tube portion and the larger-diameter tube portion by being folded the edge back to the each tube portions, wherein
a frictional member is mounted in an interior of the larger-diameter tube portion in order to control an amount of absorption of impact energy applied.

9. A shock absorber according to claim 8, wherein the step portion comprises a sectional structure in which a cross-sectional circular arc-shaped annular folded-back portion of the smaller-diameter tube portion having a smaller radius of curvature in a cross section thereof, a cross-sectional circular arc-shaped annular folded-back portion of the larger-diameter tube portion having a larger radius of curvature in a cross section thereof, an annular side surface being to join edges of the annular folded-back portions through edges thereof, and thereby forming the step portion integrally in S-shaped cross section.

10. A shock absorber according to claim 8, wherein the friction member is an annular rigid member having the outer diameter of which is smaller than the inner diameter of the larger-diameter tube portion and the inner diameter of which is larger than the outer diameter of the smaller-diameter tube portion, and the annular rigid member is inserted to the interior of the larger-diameter tube portion.

11. A shock absorber according to claim 8, wherein the frictional member is an annular elastic member having the outer diameter of which is smaller than the inner diameter of the larger-diameter tube portion and the inner diameter of which is larger than the outer diameter of the smaller-diameter tube portion, and the annular elastic member is inserted to the interior of the larger-diameter tube portion.

12. A shock absorber according to claim 8, wherein the frictional member is an annular composite member formed in one body by engaging each other with an annular elastic member having the outer diameter of which is smaller than the inner diameter of the larger-diameter tube portion and an annular rigid member having the inner diameter of which is larger than the outer diameter of the annular folded-back portion of the smaller-diameter tube portion, and the annular composite member is inserted to the interior of the larger-diameter tube portion.

13. A shock absorber according to claim 8, wherein the frictional member is an annular rigid member having the outer diameter of which is substantially equal to the inner diameter of the larger-diameter tube portion and the inner diameter of which is larger than the outer diameter of the annular folded-back portion of the smaller-diameter tube portion, and the annular rigid member is press-inserted to the interior of the larger-diameter tube portion.

14. A shock absorber according to claim 8, wherein the frictional member is an annular elastic member having the outer diameter of which is substantially equal to the inner diameter of the larger-diameter tube portion and the inner diameter of which is larger than the outer diameter of the annular folded-back portion of the smaller-diameter tube portion, and the annular elastic member is press-inserted to the interior of the larger-diameter tube portion.

15. A shock absorber according to claim 8, wherein the frictional member is an annular composite member formed in one by engaging each other with the annular elastic member having the outer diameter of which is substantially equal to the inner diameter of the larger-diameter tube portion and the annular rigid member having the inner diameter of which is larger than the outer diameter of the annular folded-back portion of the smaller-diameter tube portion, and the annular composite member is press-inserted to the interior of the larger-diameter tube portion.

16. A shock absorber according to claim 8, wherein the frictional member is elastically supported on the larger-diameter tube portion by an elastic member.
